(19) United States
(12) Patent Application Publication
(10) Pub. No.: US 2024/0094695 A1
(43) Pub. Date: Mar. 21, 2024

(54) LOAD CONTROLS WITH INTEGRAL CONTROL INTERFACES

(71) Applicant: Leviton Manufacturing Co., Inc., Melville, NY (US)

(72) Inventors: James SHURTE, New Orleans, LA (US); Ankit Milan SANGHVI, Hicksville, NY (US); Justin SIEGELWAX, Plainview, NY (US); Brian Anthony YOKUM, New Orleans, LA (US); Aaron ARD, Ponchatoula, LA (US)

(73) Assignee: Leviton Manufacturing Co., Inc., Melville, NY (US)

(21) Appl. No.: 18/522,631

(22) Filed: Nov. 29, 2023

Related U.S. Application Data
(63) Continuation-in-part of application No. 18/487,303, filed on Oct. 16, 2023.
Application No. 18/487,303 is a continuation of application No. 17/483,992, filed on Sep. 24, 2021, now Pat. No. 11,815,868.
(60) Provisional application No. 63/120,423, filed on Dec. 2, 2020.

(51) Int. Cl. G05B 19/042; G08B 5/22

(52) U.S. Cl. CPC G05B 19/042; G08B 5/22; G05B 2219/2639; G06F 3/0202

(57) ABSTRACT

Load controls are provided which include a housing including a controllably conductive switch to control electrical power to a load, a controller, and a control interface. The controller is operatively coupled to control operation of the controllably conductive switch in an operational mode, and is user-programmable in a settings mode. The control interface includes a first actuator and a second actuator. The first and second actuators are to respectively select a programmable setting and an option for the setting based on respective, specified numbers of actuations. The actuators include first and second user-activated electromechanical devices and are selectable by a user without disassembly of the load control.

### BACKGROUND

A wide variety of electrical load controls are commercially available for residential and commercial applications with various configurations and features. By way of example, load controls with integral or associated sensors, such as occupancy sensors, vacancy sensors, environmental sensors, etc., are available in a variety of configurations and features. In one or more implementations, such load controls can include one or more user-adjustable settings. For instance, in a commercial market application, the load control might be adjustable by provision of a wireless communication capability to an electronic interface to allow, for instance, a building management system to communicate with the load control. In a residential market application, a wireless communication capability is commonly omitted, with one or more settings typically being selectable by a user by partially disassembling or opening the load control to gain access to one or more setting inputs using an appropriate tool.

### SUMMARY

Certain shortcomings of the prior art are overcome and additional advantages are provided through the provision, in one or more aspects, of a load control which includes a housing configured to be installed in an electrical box. The housing includes a controllably conductive switch to control electrical power to a load, a controller, and a control interface. The controller is operatively coupled to control operation of the controllably conductive switch in an operational mode, and is user-programmable in a settings mode. The control interface includes a first actuator and a second actuator. The first actuator is to select, based on a specified number of first actuations, a programmable setting of one or more programmable settings of a settings level of the controller in the settings mode, where the first actuator includes a first user-activated electromechanical device and is selectable by a user without disassembly of the load control. The second actuator is to select, based on a specified number of second actuations, an option of multiple options of the selected programmable setting of the controller in the settings mode, where the second actuator includes a second user-activated electromechanical device and is selectable by the user without disassembly of the load control.

In another aspect, a load control is provided which includes a housing configured to be installed in an electrical box. The housing includes a controllably conductive switch to control electrical power to a load, a controller, a control interface, and one or more indicators. The controller is disposed operatively coupled to control operation of the controllably conductive switch in an operational mode, and is user-programmable in a settings mode. The control interface includes a first actuator and a second actuator, where the first and second actuators are each actuatable by a user without disassembly of the load control. When in the settings mode, the first actuator is to select, based on a specified number of first actuations, a programmable setting of one or more programmable settings of a settings level of the controller, and the second actuator is to select, based on a specified number of second actuations, an option of multiple options of the selected programmable setting of the controller. The one or more indicators are to signal at least one of the selected programmable setting of the controller, or the selected option of the selected programmable setting of the controller.

In a further aspect, a load control is provided which includes a housing configured to be installed in an electrical box. The housing includes a controllably conductive switch to control electrical power to a load, a controller, and a control interface. The controller is operatively coupled to control operation of the controllably conductive switch in an operational mode, and is user-programmable in a settings mode. The control interface includes a load control actuator, and a setup actuator. In the operational mode of the controller, actuation of the load control actuator results in the controllably conductive switch changing power to the load. The setup actuator is to select, based on a specified number of first actuations, a programmable setting of one or more programmable settings of a settings level of the controller in the settings mode, where the setup actuator includes a first user-activated electromechanical device and is selectable by a user without disassembly of the load control. The load control actuator is further configured to select, based on a specified number of second actuations, an option of multiple options of the selected programmable setting of the controller in the settings mode, where the load control actuator includes a second user-activated electromechanical device and is selectable by the user without disassembly of the load control.

In another aspect, a load control is provided which includes, for instance, a housing configured to be installed in an electrical box. The housing includes a controllably conductive switch to control electrical power to a load, a dimmer associated with the controllably conductive switch to control dimming of the electrical power to the load, a controller, and a control interface. The dimmer includes a dim actuator, a bright actuator, and a dimmer light bar to indicate a dimming level. The controller is operatively coupled to control operation of the controllably conductive switch in an operational mode, and is user-programmable in a settings mode. The control interface includes a load control actuator, and a setup actuator. In the operational mode of the controller, actuation of the load control actuator results in the controllably conductive switch changing power to the load. In the settings mode, the setup actuator is to select, based on a specified number of first actuations, a programmable setting of one or more programmable settings of a settings level of the controller in the settings mode, where the setup actuator includes a user-activated electromechanical device, and is selectable by a user without disassembly of the load control. In one or more embodiments, the controller receives a selected option of multiple options of the selected programmable setting based on a specified number of second actuations of at least one of the dim actuator, the bright actuator, or the load control actuator.

In a yet further aspect, a load control is provided which includes a housing configured to be installed in an electrical box. The housing includes a controllably conductive switch to control electrical power to a load, a controller, and a control interface. The controller is operatively coupled to control operation of the controllably conductive switch in an operational mode, and is user-programmable in a settings mode. The control interface includes a load control actuator, a setup actuator, and at least one select actuator. In the operational mode of the controller, actuation of the load control actuator results in the controllably conductive switch changing power to the load. The setup actuator is to select, based on a specified number of first actuations, a programmable setting of the one or more programmable settings of a settings level of the controller in the settings mode. The setup actuator includes a user-activated electromechanical device and is selectable by a user without disassembly of the load control. The at least one select actuator is to facilitate, at least in part, user input of one or more selections in the setting mode of the controller. The controller receives a selected option of multiple options of the selected programmable setting based on a specified number of second actuations of one or more of the at least one select actuator or the load control actuator.

Additional features and advantages are realized through the techniques described herein. Other embodiments and aspects of the invention are described in detail herein and are considered a part of the claimed aspects.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 is a schematic of one embodiment of a load control with a control assembly including an integral control interface, in accordance with one or more aspects of the present invention;

FIG. 2 depicts one embodiment of a control mode selection process of a load control, where the control includes multiple control modes selectable by a user via an integral control interface, in accordance with one or more aspects of the present invention;

FIG. 3A depicts one embodiment of control processing in a settings mode of a load control with an integral control interface, in accordance with one or more aspects of the present invention;

FIG. 3B depicts one embodiment of a settings data structure traversable by a user via a control interface for user-programming of the load control, in accordance with one or more aspects of the present invention;

FIGS. 4A-4C depict different embodiments of a wall-mount configuration of a load control, in accordance with one or more aspects of the present invention;

FIG. 5A further depicts one embodiment of the load control of FIG. 4, in accordance with one or more aspects of the present invention;

FIG. 5B is a partially exploded view of the load control of FIG. 5A, in accordance with one or more aspects of the present invention;

FIG. 5C is a cross-sectional elevational view of the load control of FIG. 5A, taken along line 5C-5C thereof, in accordance with one or more aspects of the present invention;

FIG. 6 illustrates one embodiment of the load control with the cover shown being removed to access one or more additional, user-programmable control switches, in accordance with one or more aspects of the present invention;

FIG. 7A is a plan view of one embodiment of the load control of FIG. 6 with the cover removed to expose a slide switch for transitioning the control assembly between an occupancy-sensing operational mode and a vacancy-sensing operational mode, in accordance with one or more aspects of the present invention;

FIG. 7B is an enlarged partial depiction of the load control of FIG. 7A, taken along line 7B thereof, in accordance with one or more aspects of the present invention;

FIG. 8 is a schematic of another embodiment of a load control with a control assembly including an integral control interface, in accordance with one or more aspects of the present invention;

FIG. 9 depicts one embodiment of a settings mode control process of a load control, such as depicted in FIG. 8, in accordance with one or more aspects of the present invention;

FIG. 10 depicts one embodiment of a configuration of a load control, such as depicted in FIG. 8, in accordance with one or more aspects of the present invention;

FIG. 11 depicts another embodiment of a control process of a load control such as depicted in FIGS. 8-10, in accordance with one or more aspects of the present invention;

FIG. 12 depicts an embodiment of a configuration of a dimmer load control, such as depicted in FIG. 8, in accordance with one or more aspects of the present invention;

FIGS. 13A-13G depict one embodiment of a control process of a dimmer load control, such as depicted in FIGS. 8 & 12, in accordance with one or more aspects of the present invention;

FIG. 14 illustrates an embodiment of a configuration of an occupancy sensor load control, such as depicted in FIG. 8, in accordance with one or more aspects of the present invention;

FIGS. 15A-15F depict one embodiment of a control process of an occupancy sensor load control, such as depicted in FIGS. 8 & 14, in accordance with one or more aspects of the present invention; and

FIG. 16 is a block diagram of one embodiment of a control or controller of a load control, in accordance with one or more aspects of the present invention.

### DETAILED DESCRIPTION

The accompanying figures, in which like reference numerals refer to identical or functionally similar elements throughout the separate views, illustrate embodiments of the present invention, and together with this detailed description of the invention, serve to explain aspects of the present invention. Note in this regard that, descriptions of well-known systems, devices, components, fabrication techniques, etc., are omitted so as not to unnecessarily obscure the invention in detail. It should be understood, however, that the detailed description and the specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects and features are disclosed herein, and unless inconsistent, each disclosed aspect or feature is combinable within the other disclosed aspect or feature as desired for a particular application of the concepts disclosed herein.

In addition, note that a variety of load controls with integral control interfaces are described herein by way of example only, including basic load controls, dimmer load controls, and sensor load controls. In one or more embodiments, the basic load controls, dimmer load controls, and sensor load controls include a control or controller that is user-programmable in a settings mode. Note also that the sensor load control is described herein as a load control with an occupancy sensing element. In other embodiments, the sensor load control can be, or include, for instance, a vacancy sensor, ambient light sensor, environmental sensor, or other type of sensor, for a monitored space.

As noted, in many embodiments load controls can have multiple user-configurable or programmable settings. In a commercial market application, a load control is often provided with communication capability to, for instance, an electronic interface, to allow for remote access or programming of the control. In a residential market application, however, external communication capability and/or an electronic interface are typically omitted from the load control, with one or more control settings being programable by a user partially disassembling or opening the load control, for instance, by removing a wall plate and/or cover (in a wall-mount application), to access one or more setting control inputs using an appropriate tool.

By way of enhancement, disclosed herein are electrical load controls which include, in one or more embodiments, a control assembly having a control (or controller) and a control interface. The control is user-programmable via the control interface and one or more saved settings data structures, and the control interface is accessible by a user for configuring or programming the control without any disassembly or opening of the load control, including without removal of a wall plate or other cover. Advantageously, the load controls disclosed have integral control interfaces through which a user can navigate a settings data structure (such as a menu, or a table of program settings) in a settings mode of the control, using two or more actuators (e.g., button switches) and optionally, one or more indicator devices, such as one or more light indicators, included as part of the control assembly and engageable or otherwise accessible or viewable to the user without any disassembly of the load control. In one or more embodiments, a two-actuator application is disclosed herein (by way of example), which allows a user to select different control settings for the load control from the settings data structure, with the user navigating through columns of a settings data structure using a first actuator (e.g., first button switch), and rows of the settings data structure using a second actuator (e.g., second button switch). The one or more indicator devices provide in the settings mode feedback on the column and row position that the user is currently in within the settings data structure. In one or more embodiments, the one or more indicator devices include first and second light indicators, such as first and second light-emitting diodes (LEDs), that respectively flash the current column and/or row position within the settings data structure when the control is in a settings mode, using a flashing or blinking pattern. Further, in certain embodiments, the one or more indicator devices can be used by the control to signal when settings mode has been entered or exited, as well as to signal when a selected settings option has been saved, for instance, to user-configure one or more selectable control features. The control interface disclosed herein is advantageously intuitive since it allows a user to navigate through a menu or a settings data structure using the two separate actuators, and receive feedback on the user's current position within the data structure, for instance, responsive to the user advancing to a next column or next row in the data structure, or responsive to the user selecting a particular programmable setting and/or a particular programmable setting option.

Note that the control interface disclosed herein provides the user with feedback without any graphical interface, display screen, or other electronic interface or device. For instance, in one or more embodiments, the control interface includes actuators (e.g., switch buttons) which are electromechanical devices. In one or more embodiments, the actuators include, or activate, micro-switches (e.g., controllably conductive switches), which in operational mode, control electrical power to a load. Thus, the actuators described herein include an electrical component and a mechanical component. By way of specific example, the actuators are depicted in the figures, and described hereinbelow as button switches. However, this is one embodiment only of an actuator such as described herein. Further, note that in one or more embodiments, the control interface disclosed allows a user to access different sized data structures, menus, or tables (generally referred to herein as data structures), meaning that the control interface can be used across a variety of load controls, with different sized data structures (e.g., different sized lookup tables or programming tables).

In addition, in one or more embodiments, the first and second actuators (e.g., button switches) can be used to enter multiple different control modes. In one implementation, a settings mode, or program settings mode, can be entered by, for instance, actuating the first and second button switches together for a predefined time interval, and then navigating through columns and rows of a settings data structure using single presses of the first and second button switches. This advantageously allows other features of the control assembly to be accessed by maintaining actuation (e.g., pressing and holding for a predefined time interval) of the first button switch or the second button switch, thereby allowing greater accessibility to the control operations without any disassembling of the load control, for instance, without removing or opening a wall plate, other cover or other component of the load control.

In one or more embodiments, a load control is provided which includes a housing (such as a housing configured to be installed in an electrical box or wall-box), an electrical device (e.g., a controllably conductive switch) to control electrical power to a load, and a control assembly to control the electrical device. The electrical device and the control assembly are disposed, at least partially, within the housing. The control assembly includes a control and a control interface. The control is operatively coupled to control operation of the electrical device in an operational mode, and the control is user-programmable in a settings mode via a saved settings data structure which includes multiple control settings. In one embodiment, the settings data structure includes multiple columns and rows of control settings. The control interface includes a first button switch, a second button switch, and one or more indicator devices. The first button switch is engageable by a user to selectively advance through the columns of the settings data structure in the settings mode of the control for user-programming of the control, and the second button switch is engageable by the user to selectively advance through the rows of the setting data structure in the settings mode of the control for user-programing of the control. Advantageously, the first and second button switches are selectable by the user without any disassembly of the load control. The one or more indicator devices signal, at least in part, a column of the settings data structure to which the control has been advanced in the settings mode of the control, and differently signal a row of the settings data structure to which the control has been advanced in the settings mode of the control.

One or more of a variety of indicator devices can be used as part of the control interface to, at least in part, signal a particular column and row of a settings data structure to which the control has been advanced in the settings mode. For instance, visual and/or audio signals can be used. In the case of visual signals, one or more indicators can be included to provide different light signals, and/or different indicator light devices could be utilized to provide different light location signals. For instance, in the case of light-based signal feedback, different light color signals and/or different light location signals (of the same or different colors) can be used to provide the indication of the column and/or row to which the user has advanced in the settings mode of the control.

By way of example, in certain embodiments of the present invention, the one or more indicator devices include one or more indicator lights, with the one or more indicator lights signaling in a first color (e.g., red) the column of the settings data structure to which the control has been advanced in the settings mode of the control, and signaling in a second color (e.g., green) the row of the settings data structure to which the control has been advanced in the settings mode. In one or more other implementations, the one or more indicator devices can include a first indicator device in a first location to, at least in part, signal a column of the settings data structure to which the control has been advanced in the settings mode of the control, and a second indicator device in a second location to, at least in part, signal a row of the settings data structure to which the control has been advanced in the settings mode of the control. For instance, the first indicator can include one or more first indicator lights, and the second indicator can include one or more second indicator lights. In one embodiment, the first indicator light(s) signal(s) a column of the settings data structure in the settings mode of the control by at least one of flashing a number of times corresponding to location of the column within the settings data structure or signaling a color corresponding to location of the column within the settings data structure, and the second indicator light(s) signal(s) a row of the settings data structure in the settings mode of the control by at least one of flashing a number of times corresponding to location of the row within the settings data structure or signaling a color corresponding to location of the column within the settings data structure to which the user has advanced.

By way of further example, in one or more embodiments, the one or more indicator devices include an indicator device which signals different colors for different column locations to which the user has advanced, or different row locations to which the user has advanced within the settings data structure. In one embodiment, the indicator device signals different colors for different column locations within the settings data structure, and signals different numbers of flashes for different row locations within the settings data structure. In another embodiment, the indicator device signals different numbers of flashes for different column locations within the settings data structure, and signals different colors for different row locations within the settings data structure. In one embodiment, the indicator device includes an optical element, such as a light-pipe, and the different colors for the different column locations or different row locations within the settings data structure are signaled through the optical element.

In one or more embodiments, where the one or more indicator devices include one or more indicator lights, the one or more indicator lights can be, or include, one or more light-emitting diodes (LEDs). For instance, in one embodiment, a single indicator light device can be provided which includes a bi-color, light-emitting diode. In another embodiment, two or more light-emitting diodes of different colors can be utilized as part of the control interface. For instance, in one or more embodiments, two or more light-emitting diodes of different colors can be utilized as part of a common control interface, where the two or more light-emitting diodes signal different colors through a common optical element of the indicator device. For instance, in one embodiment, the two or more light-emitting diodes can include a first color diode and a second color diode to signal through the optical element a first color, a second color, or a third color, with the third color being a combination of the first and second colors. Other variations will be apparent to those skilled in the art. Further, in certain embodiments, the one or more indicator devices can be used by the control to signal when settings mode has been entered or exited, as well as to signal when a selected settings option has been saved, for instance, to user-configure one or more selectable control features.

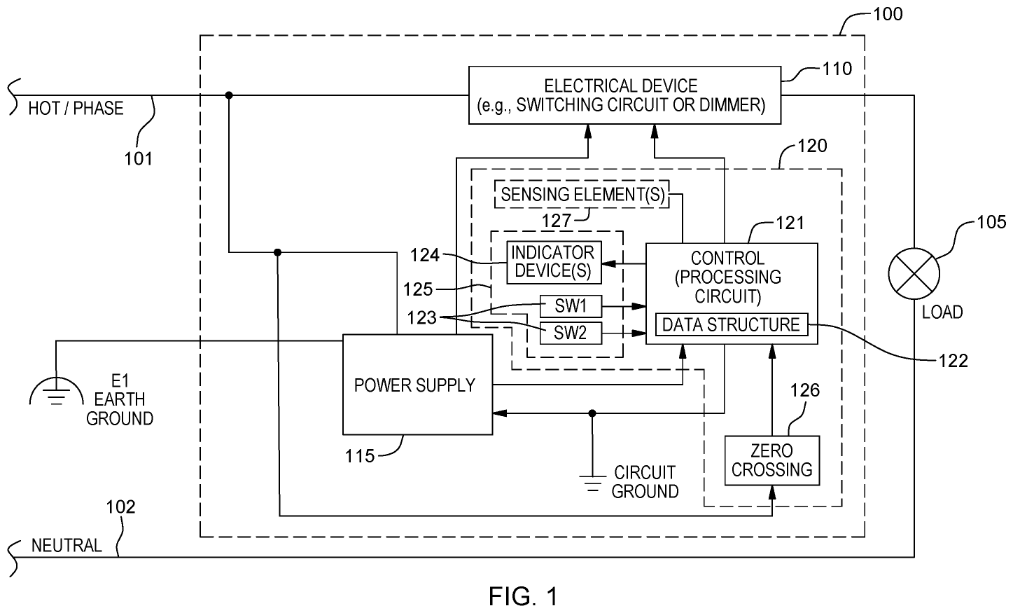

By way of example, FIG. 1 depicts a block diagram of one embodiment of a load control 100, in accordance with one or more aspects of the present invention. In one or more implementations, load control 100 is, for instance, a wall-box-type load control. In the embodiment illustrated, load control 100 includes an electrical device 110, to control electrical power to a load 105, and a control assembly 120 to control the electrical device.

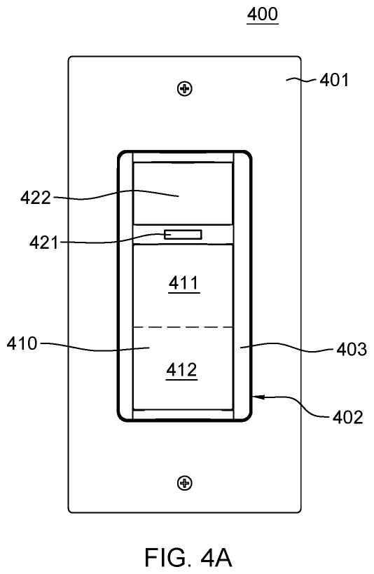

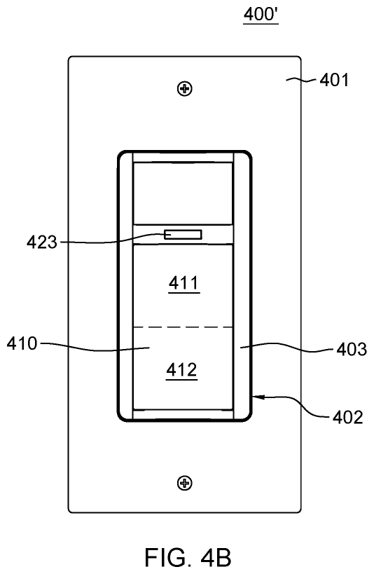

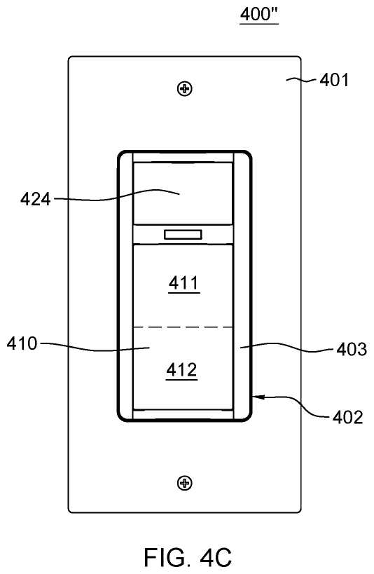

As illustrated, load control 100 is electrically connected between a power source, including a hot/phase line 101, a neutral line 102 and an earth ground E1, and load 105. In one or more embodiments, load 105 can be a lighting load, fan load, and/or other type of load. By way of example only, one detailed embodiment of a load control is depicted in FIGS. 4-7B & 16, and described further below.

In the embodiment illustrated, load control 100 includes a power supply 115 to, for instance, convert AC electrical power on hot/phase line 101 to one or more desired DC level voltages for powering electrical device 110 and/or control assembly 120. For instance, in one or more embodiments, a control or controller 121 can utilize a 1.8-5V DC voltage, such as 3V DC power, and electrical device 110 can be, in one or more implementations, an electrical switching circuit with an electrical relay driven by, for instance, 7.5V or 15V DC power, both of which can be supplied by power supply 115.

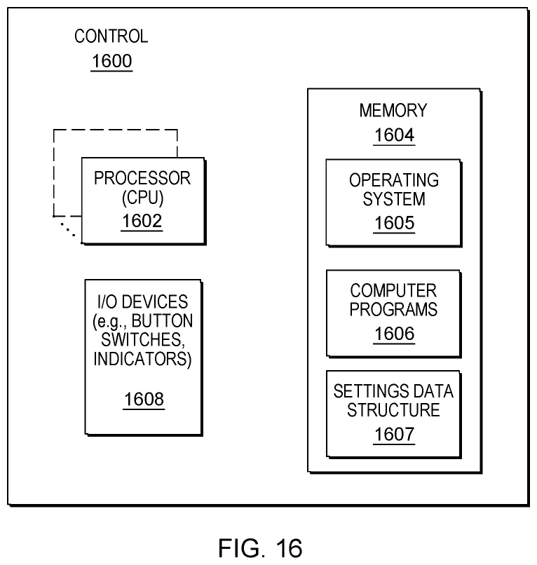

As illustrated, in one or more embodiments, control assembly 120 includes control 121, such as a processing circuit or processor, to control the electrical device based on program code. For instance, in one or more implementations, program code executing on one or more processors within control 121 controls operation of electrical device 110 in an operational mode. The control is, in one embodiment, user-programmable in a settings mode via a saved settings data structure 122 associated with the control, such as saved to memory within control 121 or memory accessible by control 121. Note that, as understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code. One example of program code, also referred to as one or more programs, is depicted in FIG. 16 as computer programs 1606, which reference one or more settings data structures 1607, both of which can be stored in memory 1604.

In the embodiment of FIG. 1, load control 100 further includes an integral control interface 125 (such as disclosed herein) which includes first and second switches 123, such as first and second button switches or contact switches, and one or more indicator devices 124, including (for instance) one or more indicator lights (such as one or more light-emitting diodes (LEDs)). In one embodiment, zero crossing circuitry 126 is also provided to, for instance, generate a time signal for control 121 where, for instance, one or more predefined time intervals are used in association with first and second button switches 123, such as to determine by control 121 whether the user wishes to enter a special mode of the control assembly, or to return to normal operational mode, such as might be the case after a defined amount of time has elapsed after a user has last provided input via the first and/or second switches 123.

Depending on the load control embodiment, control assembly 120 can include one or more sensing elements 127 for sensing one or more conditions within a monitored space. For instance, one or more sensing elements 127 can include one or more of an occupancy sensor, vacancy sensor, ambient light sensor, environmental sensor, or other type of sensor, for the monitored space. In certain embodiments, the one or more sensing elements 127 include an occupancy sensor configured to detect motion within the monitored space, with the control assembly 120 controlling electrical device 110 to switch load 105 between an ON state and an OFF state depending on the presence or absence of motion within the monitored space. For instance, when motion is detected within an area of coverage, the load can be automatically turned ON by such an occupancy-sensing load control. Alternatively, when no motion is detected, indicating the area of coverage is not occupied, the load can be automatically turned OFF by the occupancy-sensing load control after a predetermined period of time. As noted, however, an occupancy sensor is one example only of a sensing element that can be used in association with control assembly 120, or not, as may be the case with a dimmer application.

In one or more embodiments, control 121 is user-programmable via a saved settings data structure 122, and the control interface 125 is accessible by a user for configuring or programming control 121 without any disassembly or opening of load control 100, including without removal of a wall plate, cover or other component of the load control. In one or more embodiments, switches 123 are accessible either directly on the face of the load control, or indirectly, such as via a button cover and respective, flexible force transfer members, as described herein. Advantageously, the control interface disclosed herein allows a user access to different sized data structures, meaning that the control interface can be used across a variety of load controls, with different types and different sized data structures (e.g., different sized menus, lookup tables or programming tables). In addition, control 121 is configured, in one or more embodiments, so that a user can enter any of a variety of different control modes via the first and second button switches 123 of control interface 125.

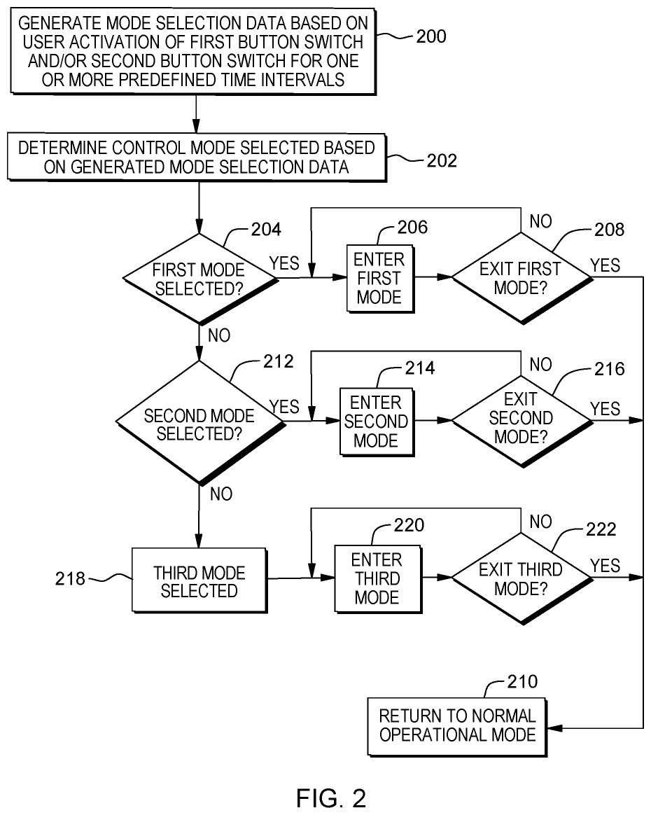

By way of example only, FIG. 2 depicts one embodiment of control processing, where the first and second button switches or contacts are used by a user to enter one of multiple control modes of the load control, with a first mode, second mode, and third mode being illustrated by way of example. As shown, mode selection data is generated based on user-activation of the first button switch and/or second button switch for one or more predefined time intervals 200. For instance, each control mode can have its own predefined time interval by which the corresponding first button switch and/or second button switch is pressed and held by the user in order to enter, or a single predefined time interval can be used across the different modes.

Program code determines the control mode selected based on the generated mode selection data 202. For instance, control processing determines whether the generated mode selection data is indicative of the user selecting a first mode 204, and if so, the first mode is entered 206. The control process stays in the first mode until a predefined exit condition is detected 208. In one or more implementations, the predefined exit condition can be a defined user input obtained via the first and/or second button switches, and/or can be based on a lapsed time. Once the predefined exit condition is detected, the control returns to normal operational mode 210 (in one embodiment).

If the generated mode selection data 202 does not indicate the first mode, then program code determines whether a second mode has been selected 212. If so, then the control enters the second mode 214, and remains in the second mode until an exit second mode condition has occurred 216, based upon which, the control returns to normal operational mode 210.

If the generated mode selection data 202 does not indicate selection of the first or second modes, then program code, in one or more embodiments, determines that a third mode has been selected 218, and the control enters the third mode 220. The control stays in the third mode until a third mode exit condition has been detected 222, and once detected, returns to normal operational mode 210.

In one or more embodiments, the first, second and third modes of FIG. 2 are first, second and third special modes of the load control. For instance, in one embodiment, the first, second and third modes are a test mode, bypass mode, and settings mode, by way of example. In certain embodiments, the first mode is selected by the user pressing the first button switch for a predefined time interval, the second mode is entered by the user pressing the second button switch for the predefined time interval, and the third mode is entered by the user pressing both the first and second button switches together for the predefined time interval. In one embodiment, the predefined time interval could be a few seconds, such as 5 seconds, to differentiate from a normal mode toggling input to the control using either the first or second button switches.

By way of example, in one embodiment, the first mode can be a test mode, which the user enters by holding the first button switch for a predefined time interval, such as 5 seconds. Once entered, the one or more indicator devices signal that the user has entered the test mode. In the case of an indicator light device, the indicator light device can blink once per second while in test mode. The test mode is exited when either the control receives data that the first or second button switches have been pressed again for a defined time interval, or after a predefined period of time has elapsed.

Further, by way of example only, the second mode can be a bypass mode, such as an auto-bypass mode. The bypass mode, which would apply for load controls with occupancy-sensing capability, enables the user to temporarily disable the auto-on feature of the load control by holding, for instance, the second button switch for a predefined time interval, such as 5 seconds. The auto-on bypass mode exits when either the first or second button switch is again pressed by the user.

In one implementation, the third mode is a settings mode, such as discussed herein. In the settings mode, the control interface, including the first and second button switches and the one or more indicator devices, allow a user to navigate through a settings data structure in order for the user to configure or program the control. The first and second button switches and the one or more indicator devices are configured and located within the load control to allow the user to access the buttons and receive the signals from the indicator device(s) from the face of the load control, that is, without any disassembly or opening of the load control, including, without removal of a wall plate, or other cover, or other component of the load control.

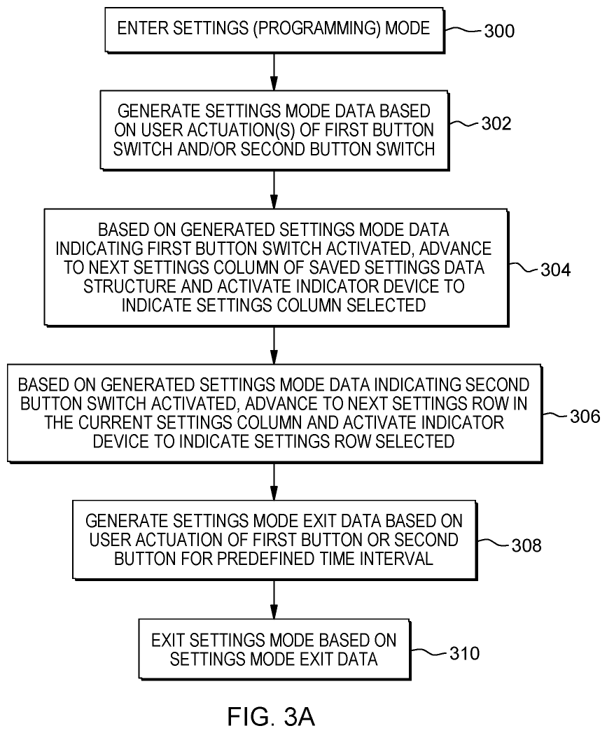

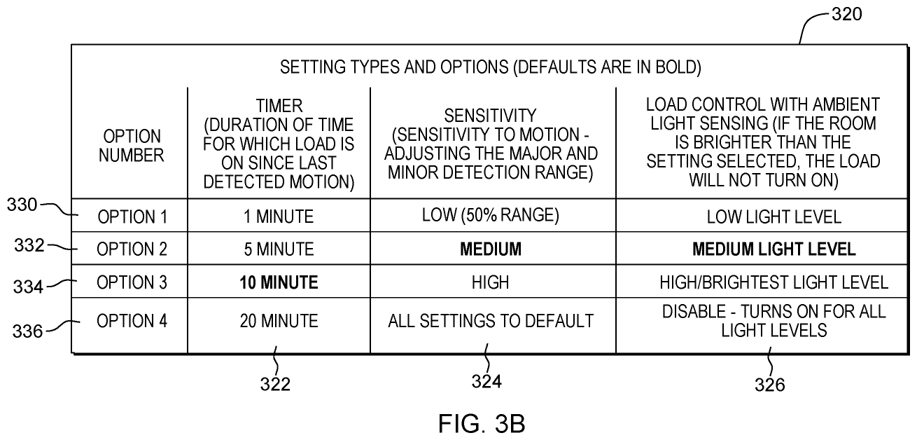

FIG. 3A depicts one embodiment of control processing based on the user entering a settings mode 300, for instance, by pressing and holding both the first and second button switches together for a predefined time interval, such as for 5 seconds, as in the above example. As illustrated, settings mode data is generated based on the user pressing or actuating the first button switch and/or second button switch 302.

By way of example only, one embodiment of a settings data structure 320 is illustrated in FIG. 3B for an occupancy-sensing load control. In the example depicted, the data structure includes multiple columns 322, 324, 326, and multiple rows 330, 332, 334, 336. As shown, a first column 322 is a timer column which indicates the duration of time for which the load is to remain ON since the last detected motion within the monitored space. A second column 324 is a sensitivity column which, in one embodiment, specifies sensitivity to motion within the monitored space, allowing the user to adjust the major and minor detection ranges. The third column 326 is an optional ambient light-sensing column, and can be provided where the load control includes both an occupancy-sensing element and an ambient light-sensing element. The ambient light-sensing column allows the user to adjust an ambient light setting, where if the room or other monitored space is brighter than the set level, then the load will not be automatically turned ON.

As illustrated, the multiple rows of settings data structure 320 provide options for each column for user-selection and configuration of the load control.

Note that where the load control includes occupancy-sensing only, then just the first and second columns, 322, 324, would be included as part of settings data structure 320. Note also, that in the embodiment of FIG. 3B, a set to default option is also included, which allows the user the ability to reset the load control to factory default conditions, with one embodiment of the conditions being illustrated in the settings data structure as the bolded options within the respective columns.

Returning to FIG. 3A, based on the generated settings mode data indicating that the first button switch has been pressed by the user, then the control advances to the next settings column of the saved settings data structure, and activates the indicator device(s) to signal the settings column selected 304. For instance, in one embodiment, upon entering the settings mode of a factory default set control unit, the default setting may be to enter the timer column 322 (FIG. 3B) at the third row 334, in the case of an occupancy-sensing load control. The user advances through the settings data structure via the first button switch to move from one column to the next, with the indicator device(s) signaling the particular column that the user has advanced to. For instance, where the indicator device is an indicator light device, the column position can be identified by a number of flashes or blinks (e.g., column 1=1 blink/second).

As illustrated in FIG. 3A, based on the generated settings data indicating that the second button switch has been pressed, the control advances to the next settings row in the current settings column, and activates the indicator device(s) to indicate the settings row selected. In the example of FIG. 3B, changing the particular option within a column is accomplished by the user advancing through the rows of the column by pressing the second button switch, with the indicator device(s) differently indicating the row position selected by a number of blinks (e.g., row 1=1 blink/second). Note in this regard, the control interface is configured so that the indicator device(s) provides a different signal to indicate advancement through the columns compared with advancement through the rows. As noted, in certain implementations, the indicator device(s) can differentiate the advancements by different color signals, and/or by flashing light signals in different locations, in the case of light-based indicator devices.

In one implementation, a particular setting can be accepted once the user is in the desired settings cell of the data structure by, for instance, holding either the first button switch or the second button switch for a predefined time interval, such as for 5 seconds, to confirm the setting 308 and generate settings mode exit data, after which, the control exits the setting mode based on the generated settings mode exit data 310. Additionally, the control can be configured so that if a user does not accept the setting to which the user has advance within a predefined time interval, for instance, within 30 seconds, then the settings will not be changed, and the load control will exit the settings mode after expiration of that time interval. In one implementation, if the user holds both the first and second button switches at the same time in the settings mode, no action will be taken by the control due to that data. Further, in one implementation, outside the settings mode, for instance, when the load control is in normal operational mode, the setting mode can be entered by the user holding both the first and second button switches together for the predefined time interval. As noted, in certain embodiments, the indicator device(s) can be used by the control to signal when settings mode has been entered or exited, as well as to signal when a selected settings option has been saved.

By way of further explanation, FIG. 4A depicts one embodiment of a wall-mounted load control 400, in accordance with one or more aspects of the present invention. In the embodiment illustrated, load control 400 includes a wall plate 401 and a cover 402, such as a color change cover, which overlies, at least in part, the control assembly of the load control. In the embodiment illustrated, cover 402 includes a cover frame 403 and a button cover 410, which overlies and covers a first button switch and a second button switch, such as discussed herein. In operation, when a user presses button cover 410 in a first region 411, the first button switch below the button cover is selected, and when the user presses the button cover 410 in a second region 412, the second button switch is selected. Additionally, a first indicator device 421 and a second indicator device 422 are provided in this embodiment, which can be respective light indicators, such as respective light-emitting diode (LED) and associated light-pipe indicators, that illuminate at different times in different control modes of the control assembly, as described herein.

FIGS. 4B & 4C depict alternate embodiments of a wall-mounted load control 400′, 400″, respectively, in accordance with one or more aspects of the present invention. In the embodiments illustrated, load controls 400′, 400″, are similar to load control 400 described above in connection with FIG. 4A, but rather use a single indicator device 423, 424, which replaces the first and second indicator devices of the embodiment of FIG. 4A. As explained herein, in one embodiment, indicator device 423, 424 can include one or more indicator lights (such as one or more light-emitting diodes) and an associated light-pipe indicator. The indicator device 423, 424 can be configured to signal different colors for different column locations or different row locations within, for instance, a settings data structure, as described. For instance, the indicator device can signal different colors for different columns locations within the settings data structure, and signal different numbers of flashes for different row locations within the settings data structure. Alternatively, the indicator device can signal different numbers of flashes for different column locations within the settings data structure, and signal different colors for different row locations within the settings data structure. In one implementation, the indicator device includes an optical element, such as a common light-pipe, and the different colors for the different column locations or different row locations within the settings data structure are signaled through the optical element. In this manner, different color lights can be combined to signal additional colors to provide, for instance, different information in different control modes of the control assembly.

By way of example only, in one or more implementations, load control 400 is a load control with occupancy-sensing capability. For instance, an occupancy-sensing load control can include any of a variety of sensor technologies, such as one or more passive infrared sensors (PIR), ultrasonic sensors (US), dual infrared-ultrasonic sensors, and the like.

In one or more embodiments, button cover 410 presents a user with a single accessible button or toggle, which in an operational mode of the control allows the user to, for instance, manually control switching ON or OFF the load. For instance, where the load control is an occupancy-sensing load control, with ambient light-sensing capability, and the control assembly is in an occupancy-sensing operational mode, with the monitored space darker than an ambient light level set, the load is automatically switched to an ON state by the load control. Alternatively, the user can switch ON the load by pressing button cover 410, which results in a pressing of the first button switch or second button switch below the button cover to manually switch the load when the control assembly is in normal operating mode. Further, the control assembly can automatically switch the load to an OFF state if no motion is detected within the monitored space for a defined time period, or if a user pushes button cover 410 to activate the first or second button switch to switch the load OFF. In this manner, such an occupancy-sensing load control provides automatic ON/OFF load control, as well as the ability for a user to manually override the automatic ON/OFF load control.

Further, in one or more implementations of an occupancy-sensing load control, the control assembly could be configured to be programmable between an occupancy-sensing operational mode and vacancy-sensing operational mode. In vacancy-sensing operational mode, when the load control is manually turned ON, the sensor assembly automatically turns OFF the load when motion is not detected for a defined interval. In the vacancy-sensing operational mode, the user can override this automatic feature by pressing button cover 410 to engage at least one of the first or second button switch to manually turn the load ON or OFF, as desired.

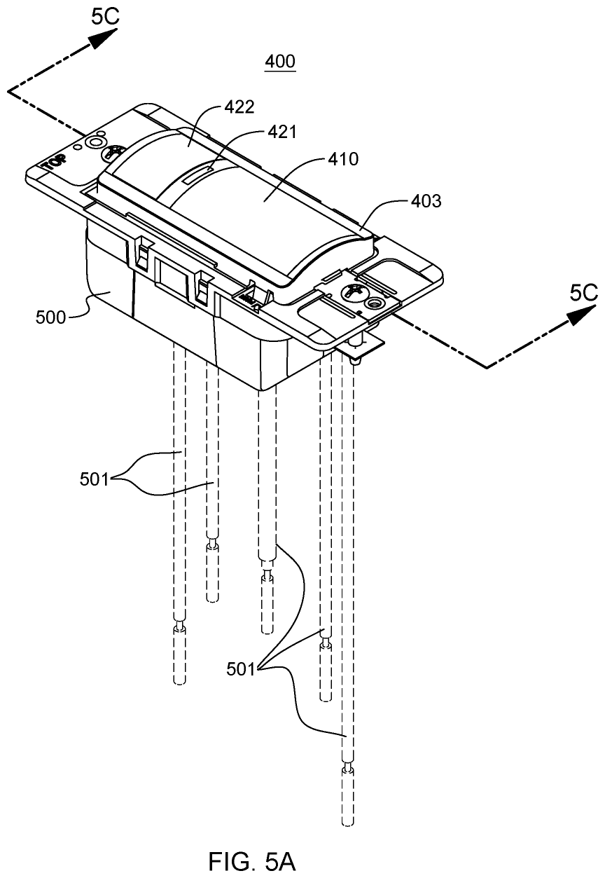

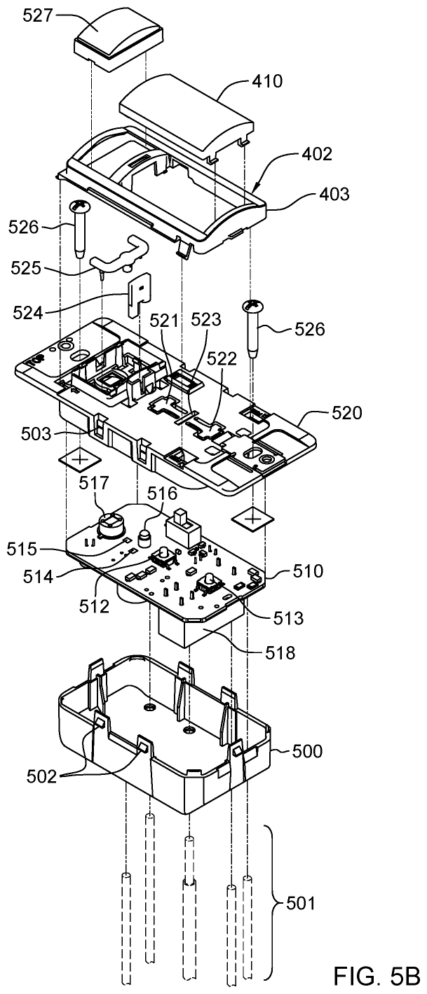

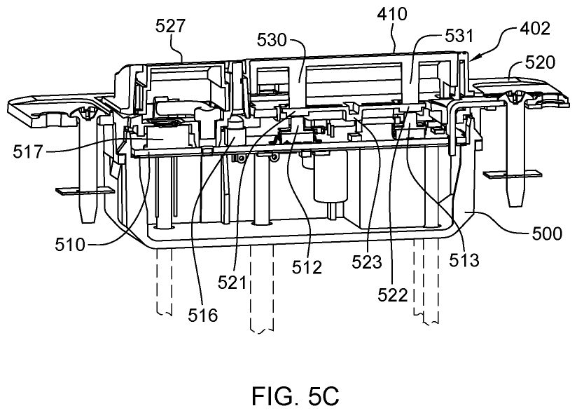

FIGS. 5A-7B depict a more detailed view of one embodiment of load control 400, in accordance with one or more aspects of the present invention. As noted, and by way of example only, load control 400 is configured with sensing capability, and more particularly, in one embodiment as an occupancy sensor or vacancy sensor, or other type of sensor for a monitored space. Note that this is one example only of a load control with integral control interface for user-configuring or user-programing of one or more data structures, such as one or more settings data structures of the load control. In one or more other embodiments, load control 400 could be configured without any sensing capability, such as the case with a dimmer-type load control with user-programmable features and an integral control interface, such as disclosed herein.

Referring collectively to FIGS. 5A-5C, cover 402 includes cover frame 403, movable button cover 410, and a cover lens 527 which overlies, in one embodiment, one or more sensing elements of the load control. Note that in operation, button cover 410 is pressable and inwardly moveable with reference to cover frame 403. As illustrated, cover 402 mechanically couples to a housing, including an upper housing 520 and a base housing 500 which accommodates, at least in part, an electrical device and a control assembly, such as described herein. In the embodiment illustrated, a circuit board 510 is provided for accommodating the electrical device, control assembly, and one or more aspects of the control interface. As illustrated, upper housing 520 is configured as a strap for mounting to, for instance, a wall-box, via one or more fasteners 526. Base housing 500 and upper housing 520 are mechanically coupled together via integrally-formed fastening elements 502, 503. In operation, wires (or lines) 501 connect to circuit board 510 and extend through base housing 500 to allow connection of the load control between, for instance, a power source and a load, as described herein. In one or more embodiments, upper housing 520 and base housing 500 are formed of an insulative material, such as a plastic material.

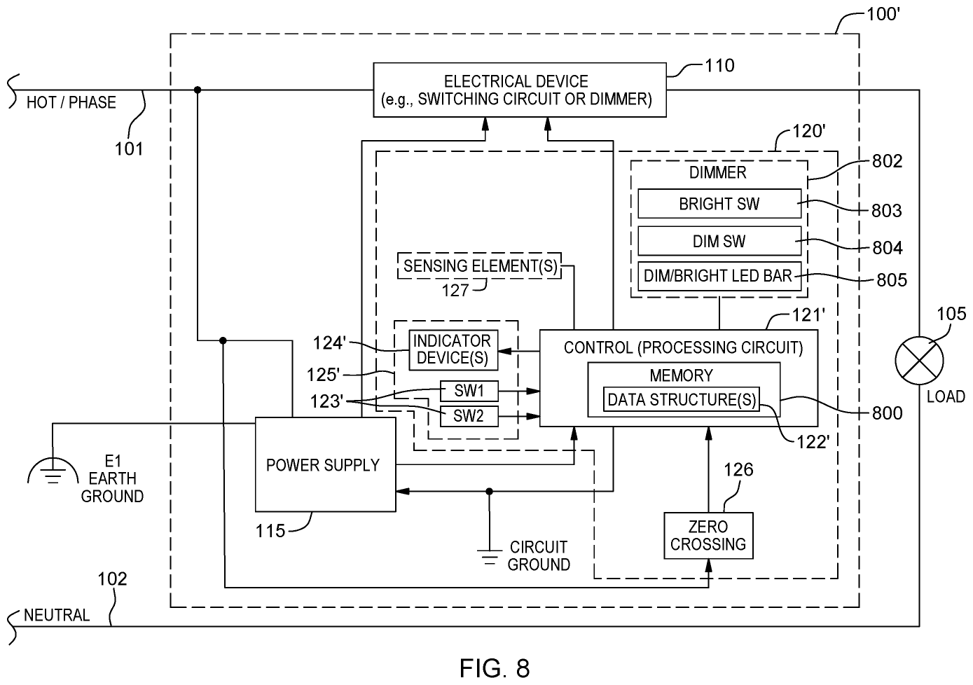

In the illustrated embodiment of FIGS. 5A-5C, circuit board 510 supports on upper and lower surfaces thereof, the electrical and electromechanical components of load control 400, including electrical device 518, such as a switching circuit or relay (in one or more embodiments), and a control or processing circuit as described herein including, for instance, a processor and associated memory, which are discussed further below with reference to FIG. 8. Additionally, circuit board 510 includes a first button switch 512 and a second button switch 513, as well as a first surface-mount, light-emitting diode (LED) 514 and a second surface-mount, light-emitting diode (LED) 515, with respective light-pipes 524, 525. Together, first LED 514 and light-pipe 524 form one embodiment of a first indicator 421 (FIG. 4A), and second LED 515 and light-pipe 525 form one embodiment of a second indicator 422 (FIG. 4A), which shines through a lens cover 527 (FIGS. 5A-5C), coupled (as noted) to frame 403 of cover 402. In one embodiment, cover 402 can be a color change cover or kit which can be removably clipped to, for instance, upper housing 520, as illustrated, and cover lens 527 is configured to refract infrared radiation onto an infrared sensor, in the case of an occupancy-sensing load control. As noted, in the embodiment depicted, this cover lens 527 also functions as a second indicator interface by locating indicator light 515 and associated light pipe 525 below the cover lens, that is, in addition to an occupancy-sensing element 517.

Circuit board 510 further includes, in one embodiment, an ambient light-sensing element 516, that is, in addition to occupancy-sensing element 517, such as a passive infrared sensor (PIR), in one embodiment.

Advantageously, in the load control embodiment of FIGS. 5A-5C, button cover 410 is provided over first button switch 512 and second button switch 513. As illustrated in FIG. 5C, button cover 410 is, in one or more embodiments, a single-piece, rigid cover pressable by a user to actuate either or both first button switch 512 and second button switch 513 via transfer of force through respective depending structures 530, 531 of button cover 410 across upper housing 520 to first button switch 512 and/or second button switch 513. As illustrated in FIG. 5B, upper housing 520 includes partially cut-out flexible members 521, 522, which flex downward from a central joint or location 523 formed in upper housing 520 such that, depending on where a user presses button cover 410, force is transferred to either first button switch 512, or second button switch 513, or both first and second button switches 512, 513. For instance, when the user presses in a first region 411 (FIG. 4A), force is transferred via structure 530 and flexible member 521 to first button switch 512, and when a user presses button cover 410 in a second region 412 (FIG. 4A), force is transferred via structure 531 and flexible member 522 to second button switch 513. When a user presses both the first and second regions of button cover 410 together, then both the first and second button switches are pressed.

As noted, the first and second button switches, and one or more indicator devices, together make up an integral control interface which allows a user to access and traverse through data structures of various sizes and content for different load controls. In this manner, the control interface can be used across a variety of load controls, including load controls with a sensing capability, or load controls without sensing capability, as in the case with a dimmer load control, with user-programmable features saved in an appropriate data structure. Note that the first and second button switches and one or more indicator devices are accessible and viewable, respectively, from the face of the load control, that is, through cover 402 of the load control, without any disassembly of the load control or opening of the load control. Further, button cover 410 advantageously provides a single surface for a user to press in order to actuate or toggle the first button switch and/or second button switch, as described herein.

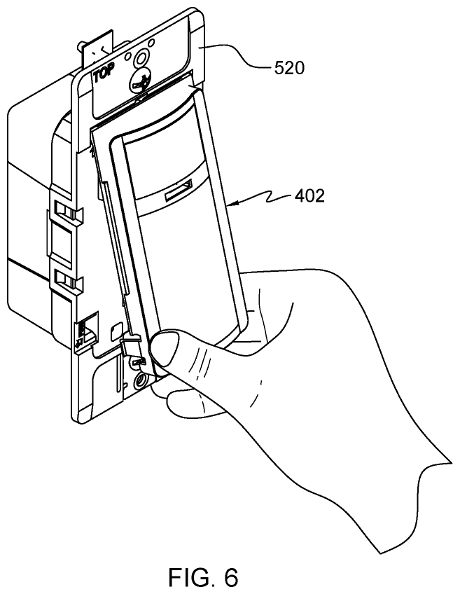

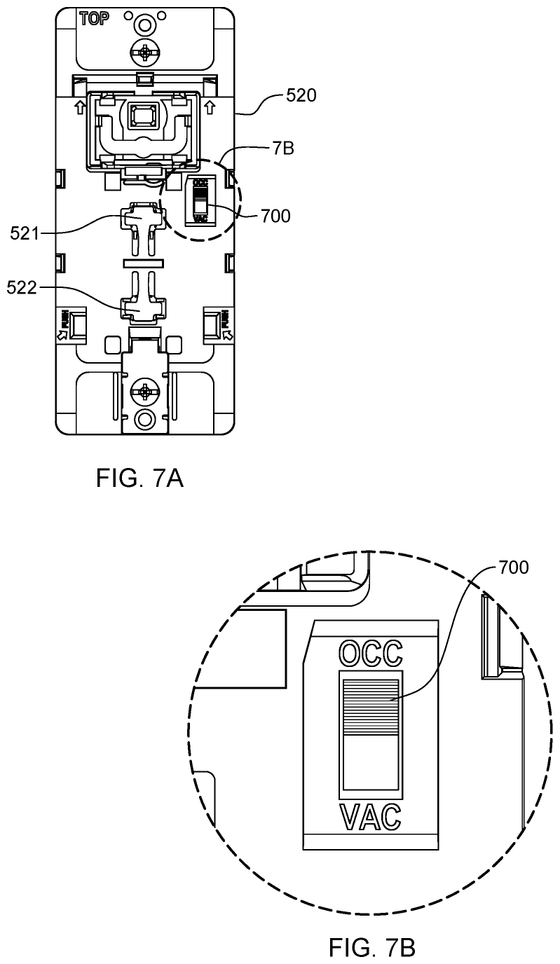

Depending on the number of special modes, one or more further load control features can be user-controlled by manually removing or opening cover 402 to expose upper housing 520, as illustrated in FIGS. 6-7B. As shown in FIGS. 6-7B, in one embodiment, a slide switch 700 can be provided extending through upper housing 520 (with flexible transfer elements 521, 522), as shown. Note with regard to FIGS. 6-7B, that no tools are required in order to remove cover 402 to expose slide switch 700, which in the embodiment illustrated, is a slide switch to allow user-setting of the load control as either an occupancy-sensing load control or a vacancy-sensing load control. In the configuration illustrated, clasps or clips are formed integral to cover 402 which engage corresponding formations in upper housing 520. By pressing in the clasps, the cover can be removed as illustrated in FIG. 6. Note that other special control modes can also be configured in a similar manner, that is, if further accessible modes are desired for a particular control load implementation beyond three modes, which are accessible as described above via the button cover 410 and first and second button switches 512, 513, without any disassembly or opening of the load control.

As noted, the occupancy-sensing load control of FIGS. 4A-7B is provided by way of detailed example only. Those skilled in the art should note that the integral control interface disclosed herein for user-configuring or programming of one or more features of the load control via a settings data structure can be integrated with a variety of load controls, including load controls without any sensing capability. In one example, the load control could be a dimmer-type load control with user-programmable features, with those features being programmed via a control interface, such as disclosed herein.

As described herein, in one or more implementations, a control assembly or system as presented includes a control or controller with memory and/or storage and a processing circuit or processor, where the memory stores program instructions or code for execution by the processing circuit to perform actions such as described herein. In this regard, the control assembly or controller can be regarded as a computing system or environment capable of executing program instructions.

As understood by one skilled in the art, program instructions or code, as referred to in this application, can include software and/or hardware. For example, program code in certain embodiments of the present disclosure can utilize a software-based implementation of the functions or operations described, while other embodiments can include fixed function hardware. Certain embodiments can combine both types of program code, such as in a firmware-based implementation. Examples of program code, also referred to as one or more computer programs, are depicted in FIG. 16, including operating system 1605 and computer programs 1606, which are stored in memory 1604. Further, in one or more embodiments, the control or controller of the load control disclosed herein can be implemented using firmware, which performs or supports the load control functions or capabilities described.

By way of further enhancement, disclosed herein are load controls which include, for instance, a housing configured to be installed in an electrical box. The housing includes a controllably conductive switch to control electrical power to a load, a controller, and a controller interface. The controller is operatively coupled to control operation of the controllably conductive switch in an operational mode, and is user-programmable in a settings mode. The control interface includes a first actuator and a second actuator. The first actuator is to select, based on a specified number of first actuations, a programmable setting of one or more programmable settings of a settings level of the controller in the settings mode, where the first actuator includes a first user-activated electromechanical device and is selectable by a user without disassembly of the load control. The second actuator is to select, based on a specified number of second actuations, an option of multiple options of the selected programmable setting of the controller in the settings mode, where the second actuator includes a second user-activated electromechanical device and is selectable by the user without disassembly of the load control.

In one or more load control implementations, the control interface further includes one or more light indicators to signal at least one of the selected programmable setting of the controller, or the selected option of the selected programmable setting of the controller in the settings mode. In one embodiment, the one or more light indicators are controlled to differently signal the selected programmable setting of the controller and the selected option of the selected programmable setting of the controller in the settings mode.

In an embodiment, the controller, is placed into the settings mode based on maintaining an actuation of the first actuator for a defined time interval, and the one or more light indicators indicate entry into the settings mode of the controller based on a release of the first actuator. Further, in one or more embodiments, the controller saves the selected option of the selected programmable setting, and returns to the settings level of the settings mode based on a further actuation of the first actuator. In one implementation, the controller transitions from the settings mode to the operational mode based on maintaining an actuation of the first actuator for another defined time interval, where the one or more light indicators further indicate entry into the operational mode of the controller based on a release of the first actuator.

In one embodiment, the one or more light indicators signal the selected programmable setting via a first respective light signal pattern, and signal the selected option via a second respective light signal pattern, where the second respective light signal pattern is different from the first respective light signal pattern. In one embodiment, the first and second respective light signal patterns each include a unique light signal pattern of one or more light colors, or one or more light colors and duty cycles of light flashes. In one specific embodiment, the one or more light indicators include one or more multicolored light-emitting diodes.

In one or more load control embodiments, in the operational mode, the controllably conductive switch changes power to the load based on actuation of the first actuator or the second actuator. In one embodiment, in the operational mode, the controllably conductive switch at least one of transitions the load between an ON state and an OFF state, or transitions a bright level or dim level of the load.

In one or more embodiments, the controller receives, based on a specified number of first actuations being within a first time interval, an indication of the programmable setting of the one or more programmable settings, and the controller receives, based on the specified number of second actuations being within a second time interval, an indication of the option of the multiple options.

In one or more implementations, load control embodiments are disclosed herein which include a controller (i.e., control) and a control interface. The control is user-programmable via the control interface and one or more saved menus or data structures identifying available programmable settings, and associated programmable options, for the load control. The control interface is accessible by a user for configuring or programming the controller without any disassembly or opening of the load control, including without removal of a wall plate or other cover. Advantageously, the load controls disclosed have integral control interfaces through which a user directly accesses one or more settings/options data structures in a setting mode of the control, using two or more button switches and one or more indicator devices, such as one or more light indicators, included as part of the control assembly, and engageable/viewable by the user without any disassembly of the load control.

By way of example, 2-actuator and 4-actuator (e.g., 2-button switch and 4-button switch) implementations are described below with reference to FIGS. 8-15F, where a user can directly select from different programmable settings for a load control with reference to one or more saved data structures of the load control. In one or more embodiments, the user directly accesses via a first actuator a desired programmable setting of one or more programmable settings by inputting a respective number of first actuations corresponding (in the one or more data structures) to that programmable setting (e.g., within a defined time interval), and directly accesses via a second actuator a desired option of multiple options for the selected programmable setting by inputting a respective number of second actuations corresponding to that particular option (e.g., within another defined time interval). As explained further herein, in one or more particular embodiments, a 2-actuator (e.g., 2-button switch) application includes a first actuator and a second actuator, where the first actuator is, for instance, a setup (or settings) actuator, and the second actuator is a load control actuator, by way of example only. A 4-actuator (e.g., 4-button switch) implementation can include, in addition to the setup actuator and the load control actuator, a dim actuator and a bright actuator.

Note that the direct-access approaches described hereinbelow with reference to FIGS. 8-15F are, in part, a variation on the above-described approaches of FIGS. 1-7B of transitioning through columns and rows of a table data structure to arrive at a desired location for programming of a selected setting and option. In the direct-access embodiments described below, the controller is configured so that in the settings mode, a specified number of actuations (e.g., presses) of one of the actuators, such as presses of a setup button switch, directly accesses a corresponding programmable setting, and a specified number of other actuator actuations, such as presses of a load control button switch, directly accesses a selected option of multiple options for that programmable setting.

In one or more embodiments, the one or more indicator devices include one or more light indicators, also referred to herein as one or more status lights, which can include one or more light-emitting diodes (LEDs) that the controller actuates to provide a unique light signal pattern corresponding to the selected programmable setting, and a unique light signal pattern corresponding to the selected option for that programmable setting. Note that, as one specific example only, a status light can be a multicolor light-emitting diode capable of signaling green, yellow, and/or red, separately or together in any desired color set combination and duty cycle (or pace) of color flashes. For instance, in one or more embodiments, the unique light signal pattern can include one or more light colors assigned to the particular programmable setting or option selected, or one or more light colors and light flashes (including duty cycle or pace of light flashes) that uniquely identify the particular programmable setting or option selected. Further, in one or more embodiments, the one or more status lights can be used by the control to signal when the settings mode has been entered or exited, as well as to signal when a selected setting option has been saved, for instance, to facilitate user-configuring of one or more selectable control features of the load control. The control interface disclosed herein is advantageously operated intuitively since it allows a user direct access to a desired programmable setting, and direct access to a desired option using two or more separate button switches, and at each step provides the user with feedback on the control mode, selected setting and/or selected option. As noted above, the control interfaces of the load controls disclosed herein provide the user with control and feedback without any graphical interface or display screen as part of the load control.

As noted, FIGS. 8-15F depict additional load controls with integral direct-access control interfaces, such as disclosed herein. Referring to FIG. 8, a block diagram is shown of an embodiment of a load control 100′, similar to load control 100 described above in connection with FIG. 1, but with a control or controller implemented to facilitate direct-access programming capabilities, such as disclosed herein. In one or more implementations, load control 100′ is, for instance, a wall-box-type load control, and includes an electrical device 110 (e.g., a controllably conductive switch), to control electrical power to a load 105, and a control assembly 120′ to control the electrical device.

As illustrated, load control 100′ is electrically connected between a power source, including a hot/phase line 101, a neutral line 102 and an earth ground E1, and load 105. In one or more embodiments, load 105 can be, for instance, a lighting load, fan load, and/or other type of load.

In the embodiment of FIG. 8, load control 100′ includes a power supply 115 to, for instance, convert AC electrical power on hot/phase line 101 to one or more desired DC level voltages for powering electrical device 110 and/or control assembly 120′. For instance, in one or more embodiments, control or controller 121′ can utilize a 1.8-5V DC voltage, such as 3V DC power, and electrical device 110 can be, in one or more implementations, an electrical switching circuit with an electrical relay driven by, for instance, 7.5V or 15V DC power, both of which can be supplied by power supply 115.

In one or more embodiments, control 121′ is configured or programmed to control the electrical device with, for instance, program code executing on one or more processors or processing circuits of control 121′ controlling operation of electrical device 110 in an operational mode. The control is, in one embodiment, user-programmable in a settings mode via, for instance, one or more menus or saved settings data structures 122′ associated with the control, such as saved to memory 800 within control 121′ or memory accessible by control 121′. As noted, program code, as referred to in this application, can include software, hardware, and/or firmware. For example, program code in certain embodiments of the present invention can include fixed function hardware, while other embodiments can utilize a software-based implementation of the functionality described. Certain embodiments combine both types of program code.

In the embodiment of FIG. 8, load control 100′ further includes an integral control interface 125′ (such as disclosed herein) which includes first and second actuators or switches 123′, such as first and second button switches, contact switches, etc. (generally referred to herein as actuators or button switches) and one or more indicator devices 124′, including, for instance, one or more light indicators, such as one or more light-emitting diodes (LEDs). In one embodiment, zero crossing circuitry 126 is also provided to generate a time signal for control 121′ where, for instance, one or more predefined time intervals or timeouts are used in association with first and/or second button switches 123′, such as to determine by control 121′ whether the user wishes to enter a special mode of the control assembly, or wishes to return to normal operational mode, such as might be the case after a defined amount of time has elapsed with a user maintaining actuation (e.g., pressing and holding) of the first and/or second switches 123′.

Depending on the load control embodiment, control assembly 120′ can include one or more sensing elements 127 for sensing one or more conditions within a monitored space. For instance, one or more sensing elements 127 can include one or more of an occupancy sensor, vacancy sensor, ambient light sensor, environmental sensor, or other type of sensor, for the monitored space. In certain embodiments, the one or more sensing elements 127 include an occupancy sensor configured to detect motion within the monitored space, with the control assembly 120′ controlling electrical device 110 to switch load 105 between an ON state and an OFF state depending on the presence or absence of motion within the monitored space. For instance, when motion is detected within an area of coverage, the load can be automatically turned ON by such an occupancy-sensing load control. Alternatively, when no motion is detected, indicating the area of coverage is not occupied, the load can be automatically turned OFF by the occupancy-sensing load control after a predetermined period of time. As noted, however, an occupancy sensor is one example only of a sensing element that can be used in association with control assembly 120′, or not.

Also, depending on the load control embodiment, control assembly 120′ can include a dimmer 802 or dimmer facility, such as for a dimmer-type load control. Dimmer 802 includes, in one or more embodiments, a bright actuator (e.g., bright button switch) 803, a dim actuator (e.g., dim button switch) 804, and a dim/bright light-emitting diode (LED) bar 805 to indicate, for instance, a dimming level when the dimmer is used in operational mode of the load control.

In one or more embodiments, control 121′ is user-programmable via one or more saved settings/options data structures 122′, and the control interface 125′ is accessible by a user for configuring or programming control 121′ without any disassembly or opening of load control 100′, including without removal of a wall plate, cover or other component of the load control. In one or more embodiments, switches 123′ are accessible either directly on the face of the load control, or indirectly, such as via a button cover and respective, flexible force transfer members, as described hereinabove. Advantageously, the control interface disclosed allows a user access to different sized data structures or menus, meaning that the control interface can be used across a variety of load controls, with different types and different sized data structures (e.g., different sized menus). In addition, control 121′ is configured, in one or more embodiments, so that a user can enter or switch between different control modes via the first and/or second button switches 123′ of control interface 125′, such as disclosed herein.

In one or more embodiments, the controller (or control) includes at least an operational mode and a settings mode. In the operational mode, the controller is operatively coupled to control operation of the electrical device, such as via, button switches 123′ and/or bright and dim switches 803, 804 of the load control 100′ of FIG. 8 (in the case of a dimmer load control implementation). In the settings mode, the controller is user-programmable, such as with reference to one or more saved settings/options data structures 122′.

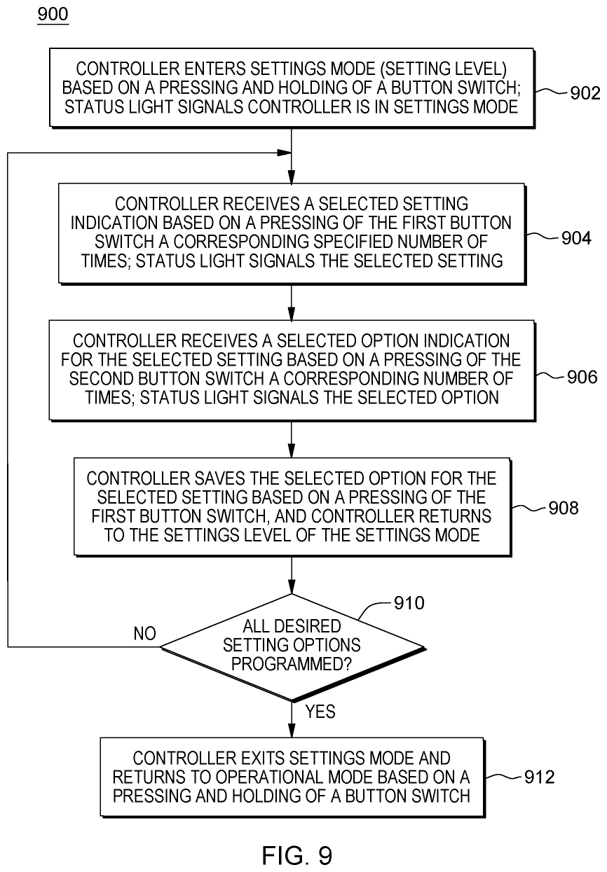

By way of example, FIG. 9 depicts one embodiment of a settings mode control process 900 of a load control, such as depicted in FIG. 8, in accordance with one or more aspects of the present disclosure. As illustrated, in one or more embodiments, with setting mode control process 900, the controller is placed into settings mode (i.e., at a settings level), based on a user maintaining actuation (e.g., pressing and holding) of an actuator or button switch, such as one of the first and second switches 123′ of control assembly 120′ of load control 100′ of FIG. 8. In one or more embodiments, the holding of the button switch is for a defined time interval, such as x seconds, at which point the button switch is released and the controller transitions from, for instance, an operational mode to the settings mode. One or more status lights (for instance, one or more light-emitting diodes) of the one or more indicator devices provided as part of the indicator device(s) are controlled by the controller to signal reaching the defined time interval, and upon release of the button switch, that the load control has entered settings mode 902.

In the embodiment of FIG. 9, in the settings mode, the controller receives a setting indication based on user-pressing, for instance, of the first actuator (e.g., first button switch) of the control interface, a corresponding specified number of times for that setting in accordance with the one or more data structures, and the controller uniquely signals the selected setting via the status light 904. Based on selection of a programmable setting, the controller then receives an option indication of multiple possible options based on user-pressing of, for instance, the second actuator (e.g., second button switch), a corresponding specified number of times. Further, the controller uniquely signals, via the status light, the selected option 906.

In one or more embodiments, the controller saves the selected option for the selected setting based on a further actuation of, for instance, the first button switch a set number of times (e.g., once), and returns to the settings level of the settings mode 908.

In one or more implementations, the controller waits at the settings level to determine whether there is a further pressing of the first button switch 910, and if “yes”, then the controller receives the further selected setting indication based on the further pressing of the first button switch a corresponding specified number of times for that setting. The controller signals, in one or more embodiments, the selected setting via the status light 904. Alternatively, where the user does not wish to program a further setting at this time, the controller exits the setting mode and returns to operational mode based on, for instance, another pressing and holding of a button switch (such as the first button switch) a predefined amount of time, such as x seconds 912. Note in this regard that the time intervals for pressing and holding the button switch to enter settings mode, and to transition from settings mode, can be the same time intervals or different time intervals, depending on the implementation.

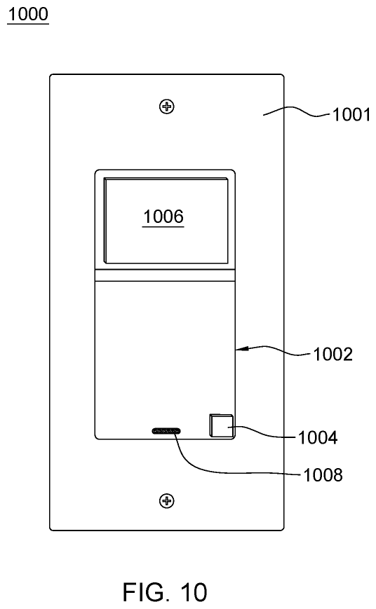

FIG. 10 depicts an embodiment of a configuration of a load control, such as described above with reference to FIGS. 8-9, in accordance with one or more aspects of the present disclosure. In the embodiment illustrated, load control 1000 is similar to or includes load control 100′ (FIG. 8), and further includes a wall plate 1001 and a cover 1002, which overlie, at least in part, the control assembly of the load control. In the embodiment illustrated, cover 1002 includes, for instance, a first button cover 1004, which overlies and covers a first actuator (e.g., first button switch), and a second button cover 1006, which overlies and covers a second actuator (e.g., second button switch), such as discussed herein. In operation, when a user presses button cover 1004, the first button switch below the button cover is actuated (that is, pressed, or engaged, etc.), and when the user presses button cover 1006, the second button switch is actuated (that is, pressed or engaged). Additionally, a light indicator 1008 of the one or more indicator devices is provided in this embodiment, which can include one or more light-emitting diodes (LEDs) and (optionally) one or more associated light-pipes, that are illuminated at different times in different control modes of the control assembly, as described herein. In one or more embodiments, the one or more light indicators form a status light, and can include one or more multicolor light-emitting diodes (LEDs), which facilitate signaling unique color patterns, such as described herein.

Note with respect to FIG. 10, that first button cover 1004 is, in one embodiment, smaller than second button cover 1006, with the first button cover covering, for instance, a setup actuator (e.g., setup button switch), and second button cover 1006 covering a load control actuator (e.g., load control button switch). Advantageously, with the depicted load control, a user can (in the settings mode) directly select via the setup actuator the setting to be programmed, that is, the precise setting at the settings level of the control process, and can directly select via the load control actuator the desired option for that setting. As described, the selected setting and option are each based on a corresponding number of specified actuations within a set time window. In this manner, a user can efficiently program the desired setting and option for the load control with reference to the one or more saved data structures.

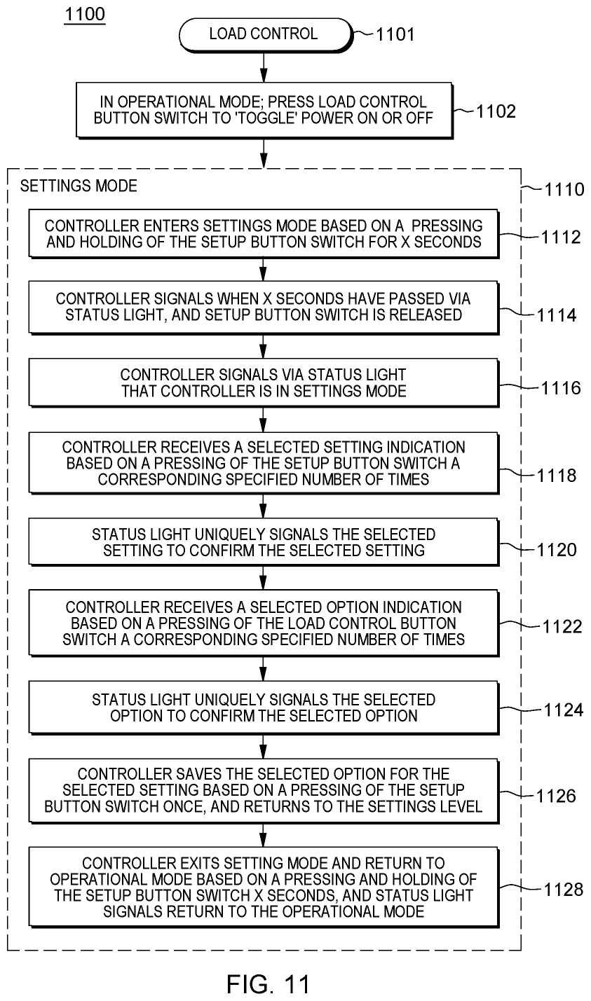

FIG. 11 depicts another embodiment of a control process 1100 of a load control, such as depicted in FIGS. 8 & 10. In one or more embodiments, load control 1101 includes, or is similar to, load control 100′ described above in connection with FIG. 8, as well as load control 1000 described above in connection with FIG. 10. As depicted in FIG. 11, load control process 1100 includes, in one or more embodiments, an operational mode 1102 and a settings mode 1110. In the operational mode, actuation of the load control actuator (e.g., load control button switch), such as a pressing of second button switch cover 1006 of load control 1000 of FIG. 10, controls the controllably conductive switch to, for instance, toggle the power between an ON state and an OFF state 1102.

In one embodiment, the controller enters settings mode 1110 based on maintaining actuation of the setup button switch for a defined interval, such as x seconds 1112. As noted, in one or more embodiments, the first button switch cover of FIG. 10 overlies, for instance, a setup button switch. In one embodiment, the controller activates the status light to signal when the defined time interval (e.g., x seconds) has been reached, based on which the setup actuator (or button switch) can be released by the user 1114. Based on the setup button switch being released, the controller enters the settings mode, at a settings level, and in one or more embodiments, the status light signals that the controller is in the settings mode 1116, for instance, by flashing green.

In the settings mode, the controller receives a selected setting indication based, for instance, on a pressing (within a defined time window) of the setup button switch a specified number of times corresponding to the desired setting to be programmed 1118. Note in this regard, that the load control, or more particularly, the controller, can include one or more levels of programmable settings, or programmable sub-settings, depending on the implementation. Based on the inputted number of actuations (e.g., button presses), the controller signals via the status light the selected setting using a unique light signal pattern of one or more light colors, or one or more light colors and light flashes 1120. With the setting having been selected, the controller can then receive a selected option indication based on actuation (e.g., pressing) of, for instance, the load control button switch a specified number of times (within a defined time window) corresponding to the desired option 1122. In the depicted embodiment, the controller uniquely signals via the status light the selected option, to confirm the selected option to the user 1124. In one or more embodiments, the controller saves the selected option for the selected setting based on a further pressing of the setup button switch (e.g., once) after the desired option has been selected, and returns to the settings level 1126. In one or more embodiments, the controller exits the settings mode and returns to the operational mode based on a pressing and holding of the setup button switch for another specified time interval, such as x seconds 1128, with the controller signaling via the status light expiration of the specified time interval, and thereafter return to the operational mode with release of the setup button switch.

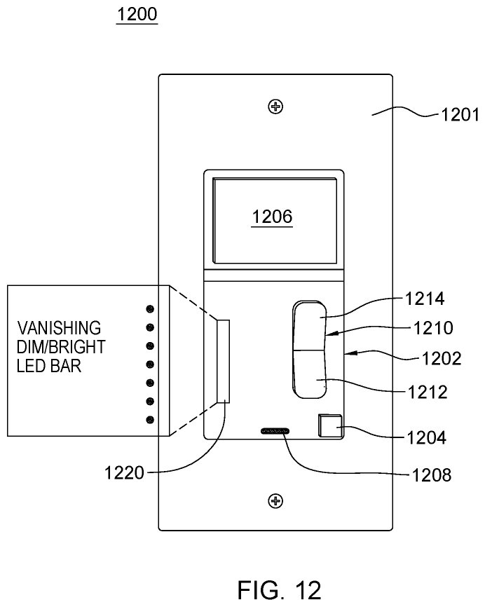

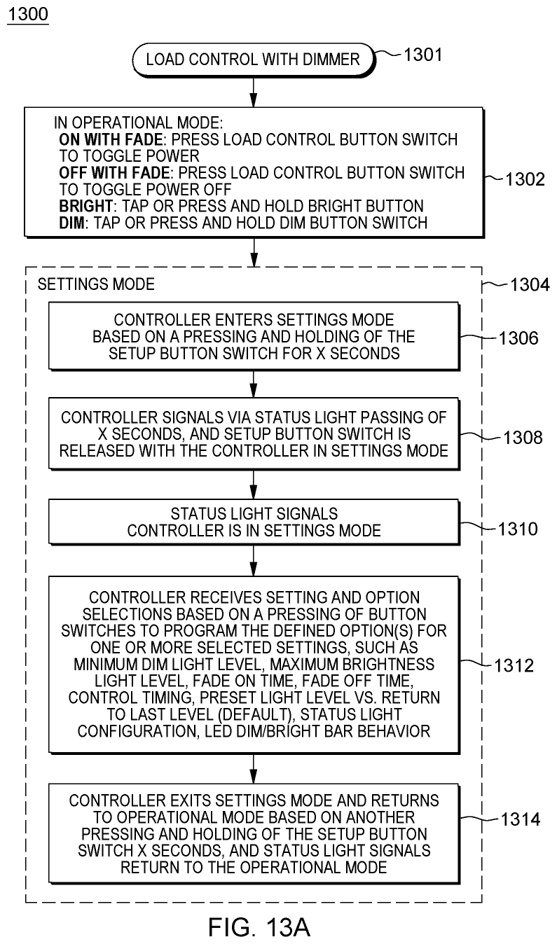

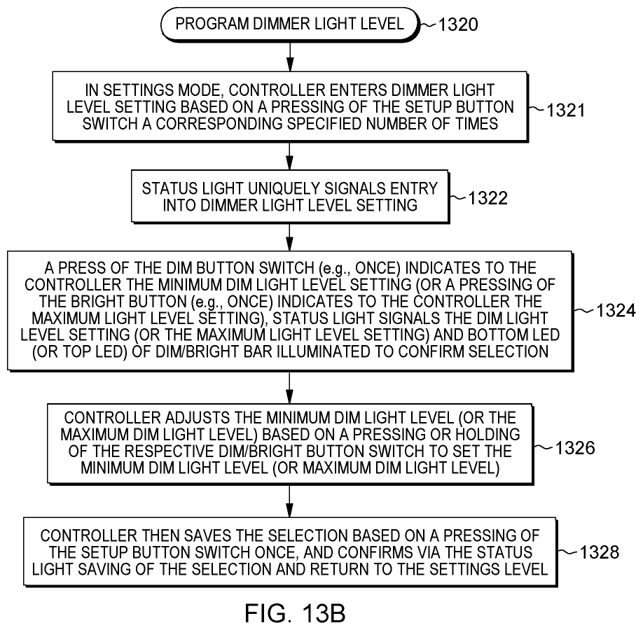

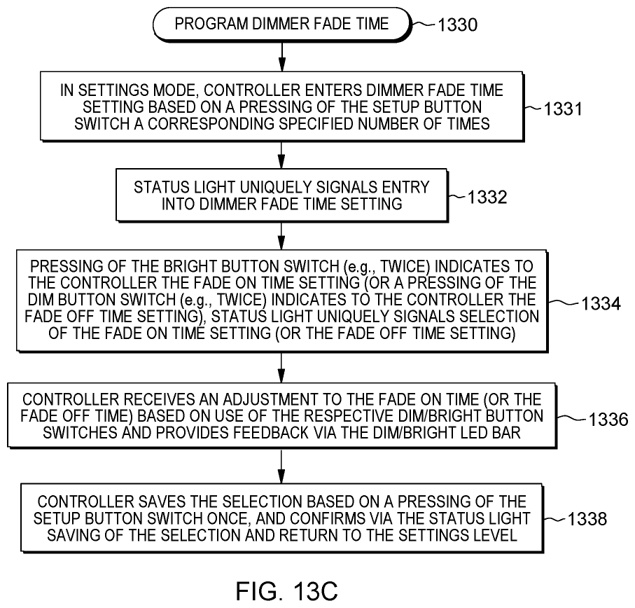

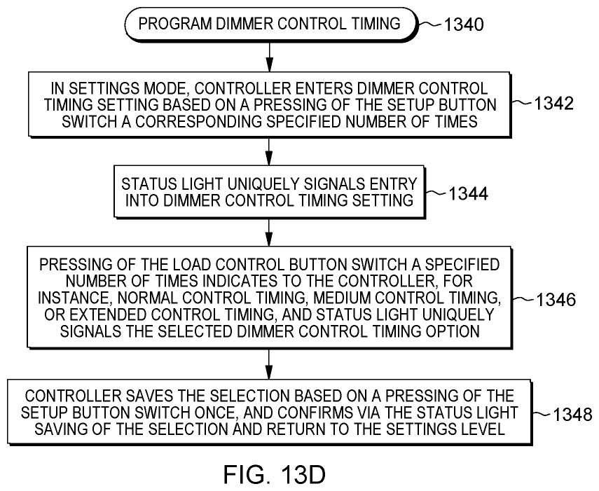

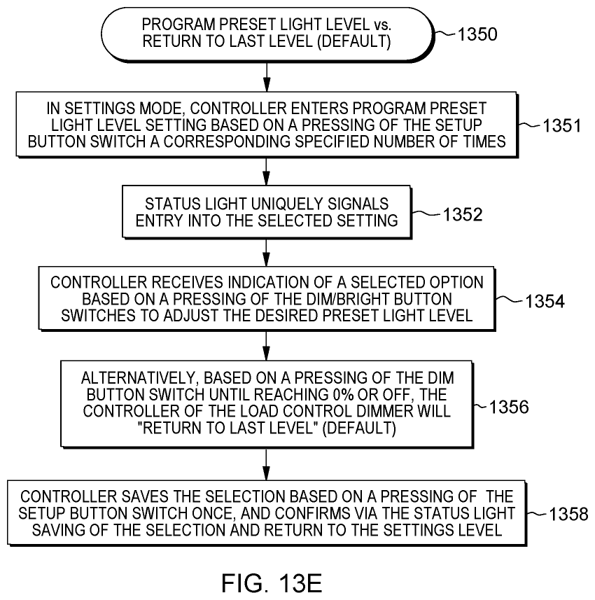

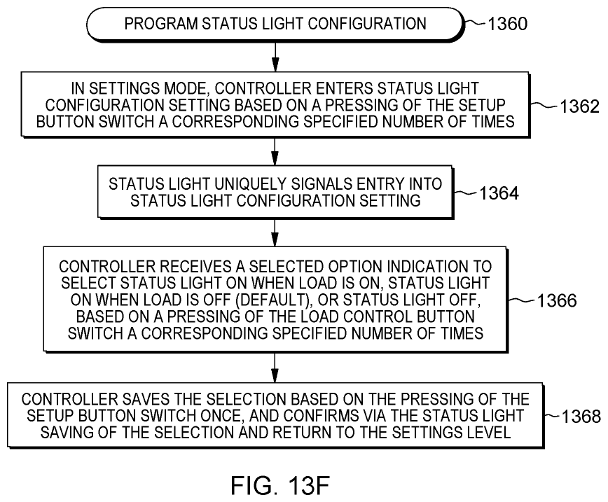

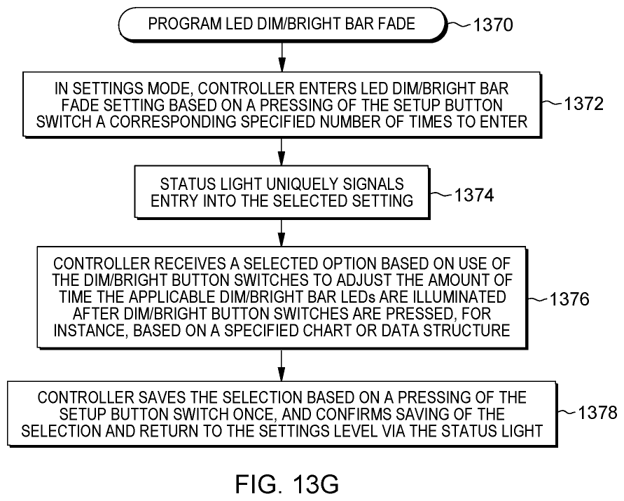

By way of additional example, FIGS. 12-13G illustrate an embodiment of a dimmer load control and process, in accordance with one or more aspects of the present invention.

FIG. 12 depicts one embodiment of a configuration of a dimmer load control, such as described above in connection with FIG. 8, in accordance with one or more aspects of the present invention. In the embodiment illustrated, load control 1200 is similar to or includes load control 100′ (FIG. 8), and further includes a wall plate 1201 and a cover 1202, which overlie, at least in part, the control assembly of the load control. In the embodiment illustrated, cover 1202 includes, for instance, a first button cover 1204, which overlies and covers a first actuator (e.g., a first button switch), and a second button cover 1206, which overlies and covers a second actuator (e.g., a second button switch), such as discussed herein. In one or more particular embodiments, the first button switch is a setup button switch, and the second button switch is a load control button switch. Further, dimmer load control 1200 includes a dimmer, or dimmer facility, such as described above in connection with FIG. 8, and includes, for instance, a dimmer button cover 1210 with a first region 1212 and a second region 1214. In operation, when a user presses dimmer button cover 1210 in first region 1212, a dim actuator (e.g., dim button switch) below the button cover is selected, and when the user presses button cover 1210 in second region 1214, a bright actuator (e.g., bright button switch) is selected. Additionally, a vanishing dim/bright light bar 1220, such as a vanishing dim/bright light-emitting diode (LED) bar, is provided as part of the dimmer facility of the control interface. In operation, the dim/bright light bar provides dim and/or brightness feedback to a user controlling dimming or brightening of the dimmer load control output via respective pressing of the dimmer button cover 1210 in the first or second region. In one or more embodiments, vanishing dim/bright light bar 1220 can be an additional indicator device of the one or more indicator devices of the control interface. As with the above-described load control 1000 of FIG. 10, a light indicator 1208 (of the one or more indicators devices) is provided, along with one or more associated light pipes, that are illuminated at different times in different control modes of the control assembly, such as described. In one or more embodiments, light indicator 1208 is a status light, and can include one or more multicolor light-emitting diodes (LEDs), which facilitate signaling the unique color patterns at different times of the control process in the settings mode, such as described.

In one or more embodiments, FIG. 12 can be generalized to a load control with one or more select button switches that facilitate, at least in part, user input of one or more selections in the settings mode of the controller. For instance, in a generalized embodiment, the load control of FIG. 12 includes two further select button switches, which can be in place of the above-discussed dim button switch and bright button switch.

To summarize, in one or more other embodiments, a load control is provided which includes a housing configured to be installed in an electrical box. The housing includes a controllably conductive switch to control electrical power to a load, a controller, and a control interface. The controller is operatively coupled to control operation of the controllably conductive switch in an operational mode, and is user-programmable in a settings mode. The control interface includes a load control actuator, a setup actuator, and at least one select actuator. In the operational mode of the controller, actuation of the load control actuator results in the controllably conductive switch changing power to the load. The setup actuator is to select, based on a specified number of first actuations, a programmable setting of one or more programmable settings of a settings level of the controller in the settings mode. The setup actuator includes a user-activated electromechanical device, and is selectable by a user without disassembly of the load control. The at least one select actuator is to facilitate, at least in part, user input of one or more selections in the settings mode of the controller. The controller receives a selected option of multiple options of the selected programmable setting based on a specified number of second actuations of one or more of the at least one select actuator or the load control actuator.

In one or more embodiments, the control interface further includes one or more light indicators to signal at least one of the selected programmable setting of the controller, or the selected option of the selected programmable setting of the controller in the settings mode.

In one or more embodiments, the control interface further includes multiple select actuators, where the at least one select actuator is at least one select actuator of the multiple select actuators. Further, in one or more embodiments, in the settings mode, the controller receives a selected programmable sub-setting of multiple programmable sub-settings of the selected programmable setting based on an actuation of a select actuator of the multiple select actuators, and based on the selected programmable sub-setting, the controller receives the selected option of the multiple options based on the specified number of actuations of another select actuator of the multiple select actuators, or of the load control actuator. In one or more embodiments, the multiple select actuators include an increase actuator and a decrease actuator. In one embodiment, the controller receives a selected option of the multiple options of the selected programmable setting based on the specified number of actuations of the increase actuator or the decrease actuator.

In one or more other embodiments, a load controller is provided which includes a housing configured to be installed in an electrical box. The housing includes a controllably conductive switch to control electrical power to a load, a dimmer associated with the controllably conductive switch, a controller, and a control interface. The dimmer includes a dim actuator, a bright actuator, and a dimmer light bar to indicate a dimming level. The controller is operatively coupled to control operation of the controllably conductive switch in an operational mode, and is user-programmable in a settings mode. The control interface includes a load control actuator, and a setup actuator. In the operational mode of the controller, actuation of the load control actuator results in the controllably conductive switch changing power to the load. In the settings mode, the setup actuator is to select, based on a specified number of first actuations, a programmable setting of the one or more programmable settings of a settings level of the controller in the settings mode, where the setup actuator includes a user-activated electromechanical device, and is selected by a user without disassembly of the load control. In one or more embodiments, the controller receives a selected option of multiple options of the selected programmable setting based on a specified number of second actuations of at least one of the dim actuator, the bright actuator, or the load control actuator.

In one or more embodiments, the control interface further includes one or more light indicators to signal at least one of the selected programmable setting of the controller, or the selected option of the selected programmable setting of the controller in the settings mode.

In one or more embodiments, in the settings mode, the controller receives a selected programmable sub-setting of multiple programmable sub-settings of the selected programmable setting based on an actuation of either the dim actuator or the bright actuator of the dimmer, and based on the selected programmable sub-setting, the controller receives the selected option of the multiple options based on the specified number of actuations of the dim actuator or the bright actuator.

In one or more embodiments, the selected programmable setting is a dimmer light level setting, and the multiple programmable sub-settings include a minimum dim-light level setting and a maximum dim-light level setting, and wherein the dimmer light bar is part of the one or more light indicators and signals the selected option for the minimum dim-light level setting or maximum dim-light level setting.

In one or more embodiments, the one or more light indicators signal the selected programmable setting via a first respective light signal pattern, and signal the selected option via a second respective light signal pattern, where the second respective light signal pattern is different from the first respective light signal pattern. In one embodiment, the first and second respective light signal patterns each include a unique light signal pattern of one or more light colors, or one or more light colors and duty cycles of light flashes.

In one or more further embodiments, a load control is provided which includes a wall-box housing, an electrical device to control electrical power to a load, a controller, and a control interface. The electrical device and the controller are disposed at least partially within the wall-box housing, and the controller is operatively coupled to control operation of the electrical device in an operational mode, and is user-programmable in a settings mode. The control interface includes a load control button switch, a setup button switch, at least one select button switch, and one or more light indicators. In the operational mode of the controller, pressing of the load control button switch results in the electrical device switching the load between an ON state and an OFF state. The setup button switch is to select, based on a specified number of setup button switch presses, a programmable setting of the one or more programmable settings of a settings level of the controller in the settings mode. The setup button switch includes a user-activated electromechanical device and is selectable by a user without disassembly of the load control. The at least one select button switch is to facilitate, at least in part, user input of one or more selections in the setting mode of the controller. The controller receives a selected option of multiple options of the selected programmable setting based on a specified number of presses of one or more of the at least one select button switch or the load control button switch. The one or more light indicators are to signal the selected programmable setting of the controller, and to signal the selected option of the selected programmable setting of the controller in the settings mode.

In one or more embodiments, the control interface can include multiple select button switches, with the at least one select button switch being at least one select button switch of the multiple select button switches. For instance, in the embodiment of FIG. 12, two additional select button switches are provided, which in the dimmer embodiment, are the above-noted dim button switch and break button switch.

In one or more embodiments, in the settings mode, the controller can receive a selected programmable sub-setting of multiple programmable sub-settings of a selected programmable setting based on a pressing of a select button switch of the multiple select button switches. As described herein, one or more programmable settings of the settings mode can have one or more programmable sub-settings, and a particular programmable sub-setting can be selected by, for instance, pressing a specified select button switch of the multiple select button switches a specified number of times corresponding to that programmable sub-setting. In one or more embodiments, the controller receives the selected option of the multiple options based on the specified number of presses of another select button switch of the multiple select button switches, or based on the specified number of presses of the load button switch.

For instance, in one or more embodiments, the multiple select button switches can include an increase button switch and a decrease button switch for use with load control implementations other than a dimmer load control implementation such as described herein. For instance, in one or more embodiments, the controller can receive the selected option of the multiple options of the selected programmable setting based on the specified number of presses of the increase button switch, or the decrease button switch.

FIG. 13A depicts an embodiment of a control process 1300 of a dimmer load control 1301, such as described above in connection with FIGS. 8 & 12. In one or more embodiments, load control 1301 is the same as, or similar to, load control 100′ (FIG. 8), as well as load control 1200 (FIG. 12). As depicted in FIG. 13A, control process 1300 includes, in one or more embodiments, an operational mode 1302, and a settings mode 1304. In the operational mode, a pressing or actuation of the load control button switch, such as via second button switch cover 1206 of load control 1200 of FIG. 12, toggles the power between an ON state with fade of one or more of the light indicators, and an OFF state with fade of one or more of the light indicators. Further, in operational mode, pressing or actuation of the bright button switch adjusts the brightness of the dim load, and pressing or actuation of the cover region over the dim button switch adjusts the dimming of the dim load, that is, in one or more embodiments, adjusts the electrical power to the load through the bright and/or dim button switches.

In the depicted embodiment, the controller enters settings mode 1304 based on a pressing and holding of the setup button switch for a defined time interval, such as x seconds 1306. The controller signals via the status light passing of the defined time interval, after which the controller enters settings mode with release of the setup button switch by the user 1308. In one embodiment, the controller signals via the status light that the controller is now in the settings mode 1310. For instance, in one embodiment, the controller can flash the status light green. In the settings mode, the controller receives setting and option selections based on user-pressing of the button switches to program the desired option for one or more selected settings, such as described further below with reference to the examples of FIGS. 13B-13G. In one or more embodiments, the selected settings can include, for instance, one or more of minimum dim light level, maximum brightness light level, fade-on time, fade-off time, control timing, preset light level versus return to last level (default), status light configuration, and/or LED dim/bright bar behavior, etc., 1312. In one embodiment, the controller exits settings mode 1304 and returns to operational mode 1302 based on another pressing and holding of the setup button switch for a defined time interval, based on which the controller signals via the status light return to the operational mode 1314.

Within the context of the control process of FIG. 13A, FIGS. 13B-13G illustrate exemplary embodiments of programming different settings in the settings mode, which are presented by way of example only.

As an example, FIG. 13B illustrates one embodiment of programming a dimmer light level 1320, in accordance with one or more aspects of the present disclosure. In the settings mode, the controller enters the dimmer light level setting based on a pressing of the setup button switch a corresponding specified number of times for that setting 1321. For instance, in one or more embodiments, the corresponding specified number of times can be one press of the setup button switch. The status light is used by the controller to uniquely signal entry into the dimmer light level setting 1322. A press of the dim button switch (e.g., once) indicates to the controller that the minimum dim light level setting is to be adjusted, or a press of the bright button (e.g., once) indicates to the controller that the maximum light level setting is to be adjusted 1324. The status light can be used by the controller to signal the minimum dim light level setting (or the maximum dim light level setting), and the bottom LED (or top LED) of the dim/bright bar can be illuminated to confirm the selection, in one or more embodiments. The controller recognizes an adjustment to the minimum dim light level (or the maximum dim light level) based on a user-pressing or holding of the respective dim/bright button switches to set the desired minimum dim light level (or maximum dim light level) 1326. Once the desired option is set, the controller saves the selection based on a pressing of the setup button switch once, and confirms via the status light saving of the selection and return to the settings level 1328. For instance, the controller can activate the status light to quickly flash green to indicate saving the selection and return to the settings level.

FIG. 13C depicts one embodiment of a program dimmer fade time control process 1330. In settings mode, the controller enters the dimmer fade time setting based on a pressing of the setup button switch a corresponding specified number of times 1331. For instance, in one or more embodiments, the setup button switch can be pressed two times within a set time window to indicate the dimmer fade time setting. The status light can be controlled to uniquely signal entry into the dimmer fade time setting 1332. In that setting, a pressing of the bright button switch (e.g., twice) can be used to indicate to the controller the fade-on time setting (or a pressing of the dim button switch (e.g., twice) can be used to indicate to the controller the fade-off time setting) 1334. The controller uses the status light to uniquely signal selection of the fade-on time setting, or the fade-off time setting. Within the selected setting, the controller receives an adjustment to the fade-on time (or the fade-off time) based, for instance, on respective presses of the dim/bright button switches within a set time period, and in one embodiment, provides feedback via the dim/bright LED bar 1336. As illustrated, the controller saves the selection based on a pressing of the setup button switch once, and confirms via the status light saving of the selection and return to the settings level 1338. For instance, the controller can be configured to quickly flash the status light green to confirm saving the selection and return to the settings level.

FIG. 13D illustrates one embodiment of a program dimmer control timing process 1340. In the settings mode, the controller enters the dimmer control timing setting based on a pressing of the setup button switch a corresponding specified number of times (e.g., three times) within a set time window 1342. The status light is controlled to uniquely signal entry into the dimmer control timing setting 1344. Based on selection of the dimmer control timing setting, pressing of the load control button switch a specified number of times within a set time period indicates to the controller, for instance, normal control timing, medium control timing, or extended control timing, and the status light is controlled to uniquely signal the selected dimmer control timing option 1346. For instance, the status light can be controlled to slowly flash green to show a normal control timing selection, to slowly flash yellow to signal a medium control timing selection, or to slowly flash red to signal an extended control timing selection. The controller saves the selection based on a pressing of the setup button switch once, and confirms via the status light saving of the selection and return to the setting level 1348. For instance, the controller can be configured to quickly flash the status light green.

FIG. 13E depicts one embodiment of a program preset light level versus return to a last set light level (default) process 1350 of a dimmer load control. In the settings mode, the controller enters the program preset light level setting based on a pressing of the setup button switch a corresponding specified number of times within a set time window 1351. For instance, in one or more embodiments, the specified number of times can be four button presses. The status light uniquely signals entry into the selected setting 1352. Once the setting is selected, the controller receives indication of a selected option based on a pressing of the dim/bright button switches to adjust the desired preset light level 1354. Alternatively, based on a pressing of the dim button switch until reaching 0%, or OFF, the load control dimmer can be configured to return to the last level (or default level) 1356. Once the desired option has been set, the controller saves the selection based on a pressing of the setup button switch once, and confirms via the status light saving of the selection and return to the settings level 1358. For instance, the controller can be configured to quickly flash the status light green.

FIG. 13F depicts one embodiments of a program status light configuration process 1360 in a dimmer load control such as described herein. In the settings mode, the controller enters the status light configuration setting based on a pressing of the setup button switch a corresponding specified number of times within a set time window 1362. For instance, the corresponding specified number of times can be five button presses, in one example. The status light uniquely signals entry into the status light configuration setting 1364. Within the setting, the controller receives a selected option indication to select status light ON when the load is ON, or an indication to select status light ON when load is OFF (default), or select status light OFF, based on a pressing of the load control button switch a corresponding specified number of times within a defined time period 1366. For instance, in one embodiment, pressing the load control button switch once selects the status light ON when load is ON option, pressing it twice, selects the status light ON when load is OFF (default) option, and pressing it three times selects the status light OFF option. The controller saves the selection based on a pressing of the setup button switch once, and confirms to the user via the status light saving of the selection and return to the settings level 1368. For instance, the controller can be configured to quickly flash the status light green to confirm saving the selection and return to the settings level.

FIG. 13G depicts one embodiment of a program LED dim/bright bar fade process of the dimmer load control 1370. In settings mode, the controller enters the LED dim/bright bar fade setting based on a pressing of the setup button switch a corresponding specified number of times within a set time window 1372. For instance, in one embodiment, the controller can be configured to recognize a pressing of the setup button switch six times as an indication that the LED dim/bright bar fade setting is to be entered. The status light is controlled by the controller to uniquely signal entry into the selected setting 1374. For instance, in one or more embodiments, the status light is controlled to quickly flash red/green. The controller receives a selected option based on use of the dim/bright button switches to adjust the amount of time the applicable dim/bright bar LEDs are illuminated after the dim/bright button switches are pressed, for instance, based on the available data structure or menu 1376. Once an option is selected, the controller saves the selection based on a pressing of the setup button switch once, and confirms via the status light saving of the selection and return to the settings level 1378, for instance, by quickly flashing the status light green.

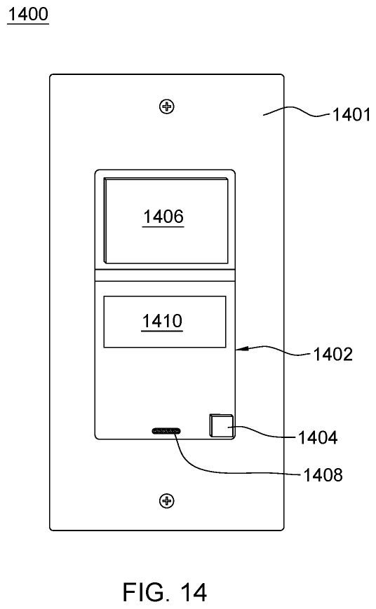

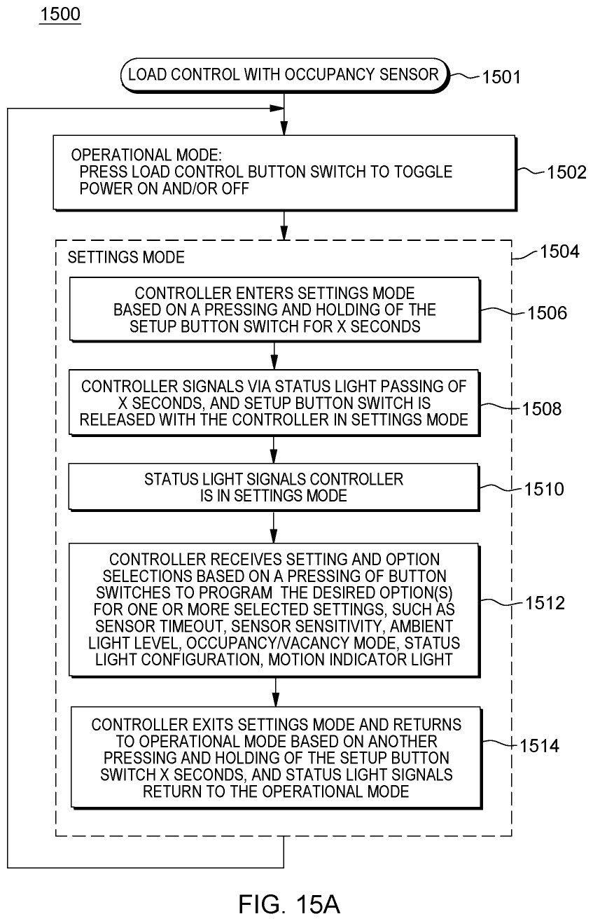

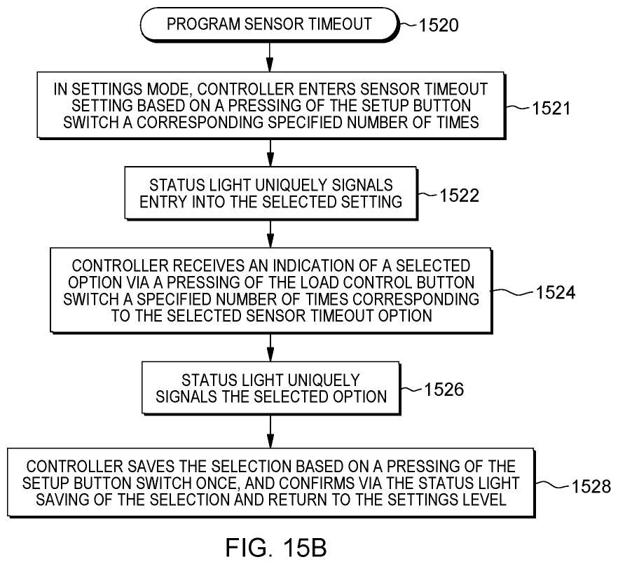

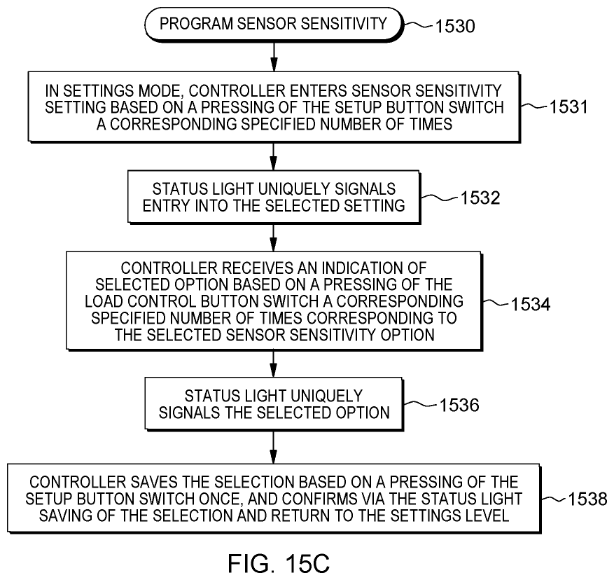

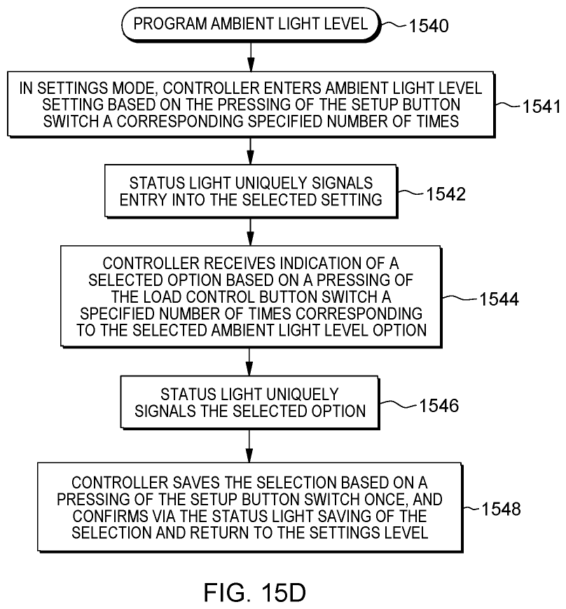

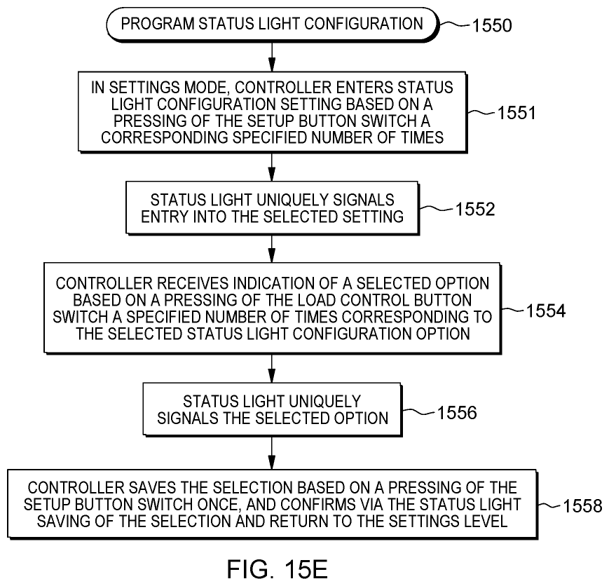

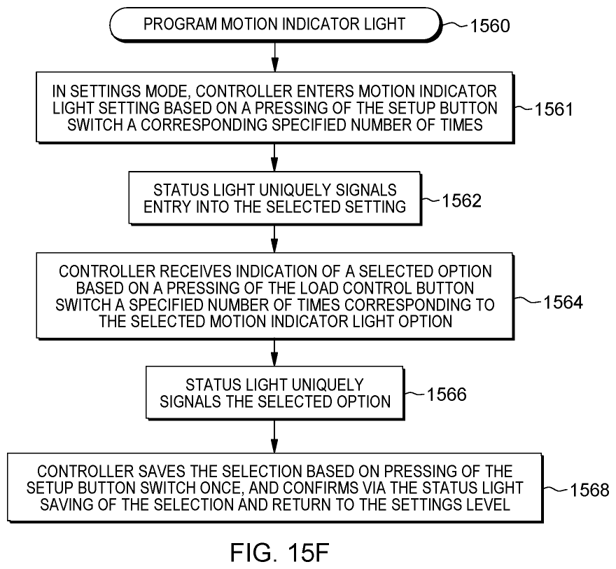

By way of additional example, FIGS. 14-15F illustrate an embodiment of an occupancy sensor load control and process, in accordance with one or more aspects of the present invention.

FIG. 14 depicts one embodiment of a configuration of an occupancy sensor load control, such as described above in connection with FIG. 8, in accordance with one or more aspects of the present invention. In the embodiment illustrated, load control 1400 is similar to or includes load control 100′ (FIG. 8), and further includes a wall-plate 1401 and a cover 1402, which overlie, at least in part, the control assembly of the load control. In the embodiment illustrated, cover 1402 includes, for instance, a first cover button 1404, which overlies and covers a first actuator (e.g., a first button switch), and a second button cover 1406, which overlies and covers a second actuator (e.g., a second button switch), such as discussed herein. In one or more particular embodiments, the first button switch is a setup button switch, and the second button switch is a load control button switch. Further, occupancy sensor load control 1400 includes one or more sensing elements 1410, such as one or more sensing elements 127 of FIG. 8. In one embodiment, one or more sensing elements 1410 include an occupancy sensor configured to detect motion within the monitored space, with the controller controlling the electrical device 110 (FIG. 8) to switch the load between an ON state and an OFF state depending, for instance, on the presence or absence of motion within the monitored space. For instance, when motion is detected within an area of coverage, the load can be automatically turned ON by the occupancy sensor load control. Alternatively, when no motion is detected, indicating the area of coverage is not occupied, the load can be automatically turned OFF by the occupancy sensor load control, such as after a predetermined period of time. An indicator light 1408 (of the one or more indicator devices) is provided, along with one or more associated light pipes, that illuminate at different times and different control modes of the control assembly, such as described herein. In one or more embodiments, light indicator 1408 is a status light, and can include one or more multicolor light-emitting diodes (LEDs), which facilitate signaling the unique color patterns at different times of the control process in the settings mode, such as described.

FIG. 15A depicts an embodiment of a control process 1500 of an occupancy sensor load control 1501, such as described above in connection with FIGS. 8 & 14. In one or more embodiments, load control 1501 is the same as, or similar to, load control 100′ (FIG. 8), as well as load control 1400 (FIG. 14). As depicted in FIG. 15A, control process 1500 includes, in one or more embodiments, an operational mode 1502, and a settings mode 1504. In the operational mode, a pressing of the load control actuator (e.g., load control button switch), such as via second button switch cover 1406 of load control 1400 of FIG. 14, controls the controllably conductive switch to, for instance, toggle the power between an ON state and an OFF state.

In the depicted embodiment, the controller enters settings mode 1504 based on a pressing and holding of the setup actuator (e.g., setup button switch) for a defined time interval, such as x seconds 1506. The controller signals via the status light passing of the defined time interval, and the controller then enters settings mode with release of the setup button switch by the user 1508. In one embodiment, the controller signals via the status light that the controller is now in the settings mode 1510. In the settings mode, the controller receives setting and option selections based on user-pressing of the button switches to program the desired option for one or more selected settings, such as described further below with reference to the examples of FIGS. 15B-15F. In an embodiment, the one or more selected settings can include, for instance, one or more of sensor timeout, sensor sensitivity, ambident light level, occupancy/vacancy mode, status light configuration and/or motion indicator light, etc., 1512. In one embodiment, the controller exits settings mode 1504 and returns to operational mode 1502 based on another pressing and holding of the setup button switch for a defined time interval, based on which the controller signals via the status light return to the operational mode 1514.

Within the context of the control process of FIG. 15A, FIGS. 15B-15F illustrate exemplary embodiments of programming different settings of the controller in the settings mode, details of which are presented by way of example only.

FIG. 15B illustrates one embodiment of programming a sensor timeout setting 1520, in accordance with one or more aspects of the present disclosure. In an embodiment, the program sensor timeout controls the time duration that a load is ON since a last-detected motion within a monitored space. In the settings mode, the controller enters the program sensor timeout setting based on a pressing of the setup button switch a corresponding specified number of times for the setting 1521. For instance, in one or more embodiments, the corresponding specified number of times can be two presses of the setup button switch. The status light is used by the controller to uniquely signal entry into the program sensor timeout setting 1522. The controller receives an indication of a selected option via a pressing of the load control button switch a specified number of times within a set time interval, where the number of presses corresponds to the selected sensor timeout option 1524. The status light uniquely signals the selected option 1526. By way of example, in one embodiment, pressing of the load control button once can result in selection of a sensor timeout of one minute, with the status light slowly flashing green to show the selection, pressing the load control button twice can result in selection of a five minute sensor timeout, with the status light slowly flashing amber to show the selection, pressing the load control button three times can result in a ten minute (or default) sensor timeout selection, with the status light slowly flashing red to show the selection, and pressing the load control button four times can result in a twenty minute sensor timeout selection, with the status light slowly flashing red/amber to show the selection. Once the desired option is set, the controller saves the selection based on a pressing of the setup button switch once, and confirms via the status light saving of the selection and return to the settings level 1528. For instance, in one embodiment, the controller can be configured to quickly flash the status light green to signal saving of the option and return to the settings level.

FIG. 15C depicts one embodiment of a program sensor sensitivity process 1530. In settings mode, the controller enters the program sensor sensitivity setting based on a pressing of the setup button switch a corresponding specified number of times 1531. For instance, in one embodiment, the setup button switch can be pressed three times within a set time window to indicate the sensor sensitivity setting, and the status light is controlled to uniquely signal entry into the selected setting 1532. For instance, in one embodiment, the status light is controlled to quickly flash green/amber to show the selection. In the selected setting, a pressing of the load control button switch a corresponding specified number of times within a defined time period selects a particular sensor sensitivity option 1534, and the status light uniquely signals the selected option 1536. For instance, the controller can be configured such that, one press of the load control button programs a low sensor sensitivity level, with the status light slowly flashing green to show that selection, two presses of the load control button selects a medium sensor sensitivity level, with the status light slowly flashing amber to show the medium sensor sensitivity level selection, and three presses of the load control button results in a high sensor sensitivity (or default) level being selected, with the status light slowly flashing red to show the selected option. The controller saves the selection based on a pressing of the setup button switch once, and confirms via the status light saving of the selection and return to the settings level. For instance, the controller can be configured to quickly flash the status light green.

FIG. 15D illustrates one embodiment of a program ambient light level process 1540. In the settings mode, the controller enters the ambient light level setting based on a pressing of the setup button switch a corresponding specified number of times (e.g., four times) within a set time window 1541. The status light is controlled to uniquely signal entry into the selected setting 1542. For instance, in one embodiment, the status light can quickly flash red/green/amber as a unique color pattern for this selected setting. Based on the selection of the ambient light level setting, pressing of the load control button switch a specified number of times within a set time period indicates to the controller, for instance, a low, medium, high, or disabled ambient light level option. For instance, pressing of the load control button once can result in the low ambient light level option being selected, with the status light slowly flashing green to show the selection, pressing of the load control button twice can result in the medium ambient light level option being selected, with the status light slowly flashing amber, pressing the load control button three times can result in the high ambident light level option being selected, with the status light slowly flashing red to show the selection, and pressing the load control button four times can result in the disabled or default ambient light level option being selected, with the status light slowly flashing red/amber to show the selection, in one embodiment only of the controller and status light. The controller saves the selection based on a pressing of the setup button switch once, and confirms via the status light saving of the selection and return to the settings level 1548. For instance, the controller can be configured to quickly flash the status light green to confirm saving of the selection and return to the settings level.

FIG. 15E depicts one embodiment of a program status light configuration process 1550 of the occupancy sensor load control. In the settings mode, the controller enters the status light level setting based on a pressing of the setup button switch a corresponding specified number of times within a set time interval 1551, and uniquely signals entry into the selected setting using the status light 1552. For instance, in one embodiment, the specified number of times can be five setup button switch presses, with entry into the status light configuration setting being signaled by the status light quickly flashing red/green. Based on the setting being selected, the controller then receives an indication of a selected option based on a pressing of the load control button switch a specified number of times corresponding to the desired status light configuration option 1554, and the controller uniquely signals the selected option via the status light 1556. For instance, in one or more embodiments, the controller can be configured to have the status light ON when the load is ON by pressing the load control button switch once, with the status light slowly flashing green to show the selection, or can be programmed so that the status light is ON when the load is OFF (default) by pressing the load control button switch twice, with the status light slowly flashing amber to show the selection, or can be programmed with the status light OFF by pressing the load control button switch three times, with the status light slowly flashing red to show that particular selection. Once the desired option has been selected, the controller saves the selection based on a pressing of the setup button switch once, and confirms via the status light saving the selection and return to the settings level 1558. For instance, the controller can be configured to quickly flash the status light green to confirm saving of the selection and return to the settings level.

FIG. 15F depicts one embodiment of a program motion indicator light process 1560 in an occupancy sensor load control such as described herein. In the settings mode, the controller enters the motion indicator light setting based on a pressing of the setup button switch a corresponding specified number of times within a set time interval 1561, and signals the selected setting via the status light 1562. For instance, in one embodiment, the controller can be programmed so that pressing the status button switch six times results in the controller entering the motion indicator light setting, with the controller signaling the selected setting by quickly flashing the status light red. Within the selected setting, the controller receives a selected option indication based on a pressing of the load control button switch a specified number of times corresponding to the desired motion indicator light option 1564, and the controller uniquely signals the selected option via the status light 1566. For instance, in one embodiment, pressing the load control button once results in the motion indicator light being enabled, with the status light slowly flashing green to show the selection, and pressing the load control button twice results in the motion indicator light being disabled, with the status light slowly flashing amber to show that selection. The controller saves the selection based on a pressing of the setup button switch once, and confirms to the user via the status light saving of the selection and return to the settings level 1568. For instance, the controller can be configured to quickly flash the status light green to show saving of the selection and return to the settings level.

Note that, in one or more embodiments, the occupancy sensor load control can be further configured to switch between an occupancy and vacancy mode of the load control, with occupancy mode being set as a default, in one embodiment. For instance, a pressing of the setup button switch a specified number of times in sequence when the device is in operational mode can result in the load control changing sensor mode. For instance, pressing of the setup button n times in sequence in operational mode of the occupancy sensor load control can result in the load control switching between occupancy mode and vacancy mode, with the controller signaling via the status light green if in occupancy mode, and red if in vacancy mode, in one embodiment only. Note that in occupancy mode, the load control is automatically ON when motion is detected, and automatically OFF when no motion is detected. For instance, in one embodiment, the load is turned ON to a last level when motion is detected (default), and is turned OFF when no motion is detected after a set time interval, such as after ten minutes (by default). In one or more vacancy mode embodiments, the user turns the load control OFF manually, and the load control waits a set time interval, for instance, 30 seconds, before monitoring for motion within the monitored space. In the vacancy mode, the load control can be turned ON manually, and automatically turned OFF. For instance, the load can automatically be turned OFF when no motion is detected after a set period of time by default, such as ten minutes (in one example). If in vacancy mode, after a load turns automatically OFF, the load control can be configured to sense for motion within the monitored space, providing an individual an opportunity to move and trigger, for instance, the lights to turn back ON automatically.

Note also that the particular colors and flash patterns described herein are presented by way of example only. Additional colors, different colors, and/or less colors can be used in one or more implementations without departing from the scope of the concepts disclosed herein.

FIG. 16 depicts one example of such a processing circuit, or computer system, and associated sensors and/or devices to incorporate and/or use aspects described herein. The computer system, which is referred to herein as a control, or controller, can be based on one or more of various system architectures and/or instruction set architectures, such as those offered by, e.g., ARM Holdings plc (Cambridge, England, United Kingdom), as an example.

FIG. 16 shows a control, controller, processing circuit, or computer system 1600 for a load control such as described herein. For instance, in one embodiment, control 1600 is an example implementation of control 121 in the load control schematic of FIG. 1 or control 121′ in the load control schematic of FIG. 8.

Control 1600 includes one or more processor(s) 1602, for instance central processing unit(s) (CPUs) and/or microprocessors. A processor can include functional components used in the execution of instructions, such as functional components to fetch program instructions from locations such as cache or main memory, decode program instructions, and execute program instructions, access memory for instruction execution, and write results of the executed instructions. A processor 1602 can also include one or more register(s) to be used by one or more of the functional components. Control 1600 also includes memory 1604, and is coupled to, or includes, input/output (I/O) devices 1608, which may be coupled to processor(s) 1602 and each other via one or more circuit board buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 1604 can be or include main or system memory (e.g. Random Access Memory) used in the execution of program instructions, storage device(s) such as hard drive(s), flash media, or optical media as examples, and/or cache memory, as examples. Memory 1604 can include, for instance, a cache, such as a shared cache, which may be coupled to local caches (examples include L1 cache, L2 cache, etc.) of processor(s) 1602. Additionally, memory 1604 may be or include at least one computer program product having a set (e.g., at least one) of program modules, instructions, code or the like configured to carry out functions of embodiments described herein when executed by one or more processors.

Memory 1604 can store an operating system 1605 and other computer programs 1606, such as one or more computer programs/applications that execute to perform aspects described herein. Specifically, programs/applications can include computer readable program instructions that may be configured to carry out functions of embodiments of aspects described herein. Further, memory 1604 can include one or more settings data structures 1607 of the load control, such as described herein.

Examples of I/O devices 1608 include but are not limited to condition sensors, such as occupancy or vacancy sensors, environmental sensors, lights, sensor devices configured to sense light, proximity, body and/or ambient temperature, switches, such as button switches, indicators, such as indicator lights, etc. An I/O device can be incorporated into the control or computer system as shown, though in some embodiments an I/O device may be regarded as an external device coupled to the control or computer system through one or more I/O interfaces.

Control or computer system 1600 may be operational with numerous general purpose or special purpose computing system environments or configurations. Control 1600 can take any of various forms, well-known examples of which include, but are not limited to, a microcontroller, multiprocessor system(s), microprocessor-based system(s), systems-on-a-chip (SOCs), electronic control systems, load control switches and the like.

The present invention can be a control assembly, system, method, and/or computer program product, any of which may be configured to perform or facilitate aspects described herein.

In some embodiments, aspects of the present invention can take the form of a computer program product, which can be embodied as computer readable medium(s). A computer readable medium may be a tangible storage device/medium having computer readable program code/instructions stored thereon. Example computer readable medium(s) include, but are not limited to, electronic, magnetic, optical, or semiconductor storage devices or systems, or any combination of the foregoing. Example embodiments of a computer readable medium include a hard drive or other mass-storage device, an electrical connection having wires, random access memory (RAM), read-only memory (ROM), erasable-programmable read-only memory such as EPROM or flash memory, an optical fiber, an optical storage device, a magnetic storage device, or any combination of the foregoing. The computer readable medium may be readable by a processor, processing unit, or the like, to obtain data (e.g. instructions) from the medium for execution. In a particular example, a computer program product is or includes one or more computer readable media that includes/stores computer readable program code to provide and facilitate one or more aspects described herein.

As noted, program instruction contained or stored in/on a computer readable medium can be obtained and executed by any of various suitable components such as a processor of a computer system to cause the computer system to behave and function in a particular manner Such program instructions for carrying out operations to perform, achieve, or facilitate aspects described herein may be written in, or compiled from code written in, any desired programming language. In some embodiments, such programming language includes object-oriented and/or procedural programming languages such as C, C++, C#, Java, etc.

Program code can include one or more program instructions obtained for execution by one or more processors. Computer program instructions may be provided to one or more processors of, e.g., one or more computer systems, to produce a control assembly, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

Although various embodiments are described above, these are only examples. For example, computing environments of other architectures can be used to incorporate and use one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A load control, comprising:
a housing configured to be installed in an electrical box, the housing comprising:
a controllably conductive switch to control electrical power to a load;
a controller operatively coupled to control operation of the controllably conductive switch in an operational mode, and being user-programmable in a settings mode; and
a control interface, the control interface comprising:
a first actuator to select, based on a specified number of first actuations, a programmable setting of one or more programmable settings of a settings level of the controller in the settings mode, the first actuator comprising a first user-activated electromechanical device and being selectable by a user without disassembly of the load control; and
a second actuator to select, based on a specified number of second actuations, an option of multiple options of the selected programmable setting of the controller in the settings mode, the second actuator comprising a second user-activated electromechanical device and being selectable by the user without disassembly of the load control.

2. The load control of claim 1, wherein the control interface further comprises one or more light indicators to signal at least one of:
the selected programmable setting of the controller; or
the selected option of the selected programmable setting of the controller in the settings mode.

3. The load control of claim 2, wherein the controller is placed into the settings mode based on maintaining an actuation of the first actuator for a defined time interval, and wherein the one or more light indicators indicate entry into the settings mode of the controller based on a release of the first actuator.

4. The load control of claim 3, wherein the controller saves the selected option of the selected programmable setting, and returns to the settings level of the settings mode based on a further actuation of the first actuator.

5. The load control of claim 3, wherein the controller transitions from the settings mode to the operational mode based on maintaining another actuation of the first actuator for another defined time interval, and wherein the one or more light indicators indicate entry into the operational mode of the controller based on a release of the first actuator.

6. The load control of claim 2, wherein the one or more light indicators signal the selected programmable setting via a first respective light signal pattern, and signal the selected option via a second respective light signal pattern, wherein the second respective light signal pattern is different from the first respective light signal pattern.

7. The load control of claim 6, wherein the first and second respective light signal patterns each comprise a unique light signal pattern of one or more light colors, or one or more light colors and duty cycles of light flashes.

8. The load control of claim 7, wherein the one or more light indicators include one or more multicolored light-emitting diodes.

9. The load control of claim 1, wherein in the operational mode, the controllably conductive switch changes power to the load based on actuation of the first actuator or the second actuator.

10. The load control of claim 9, wherein in the operational mode, the controllably conductive switch at least one of:
transitions the load between an ON state and an OFF state; or
transitions a bright level or dim level of the load.

11. The load control of claim 1, wherein the controller receives, based on the specified number of first actuations being within a first time interval, an indication of the programmable setting of the one or more programmable settings, and the controller receives, based on the specified number of second actuations being within a second time interval, an indication of the option of the multiple options.

12. A load control comprising:
a housing configured to be installed in an electrical box, the housing comprising:
a controllably conductive switch to control electrical power to a load;
a controller disposed operatively coupled to control operation of the controllably conductive switch in an operational mode, and being user-programmable in a settings mode; and
a control interface comprising a first actuator and a second actuator, wherein the first and second actuators are each actuatable by a user without disassembly of the load control, wherein when in the settings mode:
the first actuator to select, based on a specified number of first actuations, a programmable setting of one or more programmable settings of a settings level of the controller;
the second actuator to select, based on a specified number of second actuations, an option of multiple options of the selected programmable setting of the controller; and
one or more indicators to signal at least one of:
the selected programmable setting of the controller; or
the selected option of the selected programmable setting of the controller.

13. A load control comprising:
a housing configured to be installed in an electrical box, the housing comprising:
a controllably conductive switch to control electrical power to a load;
a controller operatively coupled to control operation of the controllably conductive switch in an operational mode, and being user-programmable in a settings mode; and
a control interface, the control interface comprising:
a load control actuator, wherein in the operational mode of the controller, an actuation of the load control actuator results in changing power to the load;
a setup actuator to select, based on a specified number of first actuations, a programmable setting of one or more programmable settings of a settings level of the controller in the settings mode, the setup actuator comprising a first user-activated electromechanical device and being selectable by a user without disassembly of the load control; and
wherein the load control actuator is further to select, based on a specified number of load control actuations, an option of multiple options of the selected programmable setting of the controller in the settings mode, the load control actuator comprising a second user-activated electromechanical device and being selectable by the user without disassembly of the load control.

14. The load control of claim 13, wherein the control interface further comprises one or more light indicators to signal at least one of
the selected programmable setting of the controller; or
the selected option of the selected programmable setting of the controller in the settings mode.

15. The load control of claim 14, wherein the controller is placed into the settings mode based on maintaining an actuation of the setup actuator for a defined time interval, and wherein the one or more light indicators indicate entry into the settings mode of the controller based on a release of the setup actuator.

16. The load control of claim 15, wherein the controller saves the selected option of the selected programmable setting, and returns to the settings level of the settings mode based on a further actuation of the setup actuator.

17. The load control of claim 15, wherein the controller transitions from the settings mode to the operational mode based on maintaining an actuation of the setup actuator for another defined time interval, and wherein the one or more light indicators indicate entry into the operational mode of the controller based on a release of the setup actuator.

18. The load control of claim 14, wherein the one or more light indicators signal the selected programmable setting via a first respective light signal pattern, and signal the selected option via a second respective light signal pattern, wherein the second respective light signal pattern is different from the first respective light signal pattern.

19. The load control of claim 14, wherein the first and second respective light signal patterns each comprise a unique light signal pattern of one or more light colors, or one or more light colors and duty cycles of light flashes.

20. A load control comprising:
a housing configured to be installed in an electrical box, the housing comprising:
a controllably conductive switch to control electrical power to a load;
a dimmer associated with the controllably conductive switch to control dimming of the electrical power to the load, the dimmer comprising:
a dim actuator and a bright actuator; and
a dimmer light bar to indicate a dimming level;
a controller operatively coupled to control operation of the controllably conductive switch in an operational mode, and being user-programmable in a settings mode; and
a control interface, the control interface comprising:
a load control actuator, wherein in the operational mode of the controller, actuation of the load control actuator results in the controllably conductive switch changing power to the load;
a setup actuator to select, based on a specified number of first actuations, a programmable setting of one or more programmable settings of a settings level of the controller in the settings mode, the setup actuator comprising a user-activated electromechanical device, and being selectable by a user without disassembly of the load control; and
wherein the controller receives a selected option of multiple options of the selected programmable setting based on a specified number of actuations of at least one of the dim actuator, the bright actuator, or the load control actuator.

21. The load control of claim 20, wherein the control interface further comprises one or more light indicators to signal at least one of:
the selected programmable setting of the controller; or
the selected option of the selected programmable setting of the controller in the settings mode.

22. The load control of claim 21, wherein in the settings mode, the controller receives a selected programmable sub-setting of multiple programmable sub-settings of the selected programmable setting based on an actuation of either the dim actuator or the bright actuator of the dimmer, and wherein based on the selected programmable sub-setting, the controller receives the selected option of the multiple options based on the specified number of actuations of the dim actuator or the bright actuator.

23. The load control of claim 22, wherein the selected programmable setting is a dimmer light level setting, and the multiple programmable sub-settings comprise a minimum dim-light level setting and a maximum dim-light level setting, and wherein the dimmer light bar is part of the one or more light indicators and signals the selected option for the minimum dim-light level setting or maximum dim-light level setting.

24. The load control of claim 21, wherein the one or more light indicators signal the selected programmable setting via a first respective light signal pattern, and signal the selected option via a second respective light signal pattern, wherein the second respective light signal pattern is different from the first respective light signal pattern.

25. The load control of claim 24, wherein the first and second respective light signal patterns each comprise a unique light signal pattern of one or more light colors, or one or more light colors and duty cycles of light flashes.

26. A load control comprising:
a housing configured to be installed in an electrical box, the housing comprising:
a controllably conductive switch to control electrical power to a load;
a controller operatively coupled to control operation of the controllably conductive switch in an operational mode, and being user-programmable in a settings mode; and
a control interface, the control interface comprising:
a load control actuator, wherein in the operational mode of the controller, actuation of the load control actuator results in the controllably conductive switch changing power to the load;
a setup actuator to select, based on a specified number of first actuations, a programmable setting of one or more programmable settings of a settings level of the controller in the settings mode, the setup actuator comprising a user-activated electromechanical device, and being selectable by a user without disassembly of the load control;
at least one select actuator to facilitate, at least in part, user input of one or more selections in the settings mode of the controller; and
wherein the controller receives a selected option of multiple options of the selected programmable setting based on a specified number of second actuations of one or more of the at least one select actuator or the load control actuator.

27. The load control of claim 26, wherein the control interface further comprises one or more light indicators to signal at least one of:
the selected programmable setting of the controller; or
the selected option of the selected programmable setting of the controller in the settings mode.

28. The load control of claim 27, wherein the control interface further comprises multiple select actuators, the at least one select actuator being at least one select actuator of the multiple select actuators.

29. The load control of claim 28, wherein in the settings mode, the controller receives a selected programmable sub-setting of multiple programmable sub-settings of the selected programmable setting based on an actuation of a select actuator of the multiple select actuators, and wherein based on the selected programmable sub-setting, the controller receives the selected option of the multiple options based on the specified number of actuations of another select actuator of the multiple select actuators, or of the load control actuator.

30. The load control of claim 29, wherein the multiple select actuators include an increase actuator and a decrease actuator.

31. The load control of claim 30, wherein the controller receives the selected option of the multiple options of the selected programmable setting based on the specified number of actuations of the increase actuator or the decrease actuator.
